(19) United States
(12) Patent Application Publication
(10) Pub. No.: US 2011/0123868 A1
(43) Pub. Date: May 26, 2011

(54) SOLID ELECTROLYTE BATTERY, VEHICLE, BATTERY-MOUNTING DEVICE, AND MANUFACTURING METHOD OF THE SOLID ELECTROLYTE BATTERY

(76) Inventors: Hirokazu Kawaoka, Aichi (JP); Hideyuki Nagai, Aichi (JP); Shinji Kojima, Aichi (JP)

(21) Appl. No.: 12/739,196

(22) PCT Filed: Dec. 1, 2008
(86) PCT No.: PCT/JP2008/071785

§ 371 Date: Apr. 22, 2010

(51) Int. Cl. H01M 10/0562; B05D 5/12; B05D 3/14; B05D 1/36

(52) U.S. Cl. 429/304; 427/458; 427/466

(57) ABSTRACT

A purpose is to provide a solid electrolyte battery including a low-resistance solid electrolyte layer, a vehicle mounting this solid electrolyte battery, a battery-mounting device, and a manufacturing method of the solid electrolyte battery. A solid electrolyte battery 1 includes a positive active material layer 21 containing positive active material particles 22, a negative active material layer 31 containing negative active material particles 32, and a solid electrolyte layer 40 interposed therebetween. The solid electrolyte layer contains a sulfide solid electrolyte SE but no resin binder and self-maintains its shape by a bonding force of the sulfide solid electrolyte. The solid electrolyte layer has a layer thickness 40T of 50 μm or less and an area 40S of 100 cm² or more.

### CROSS-REFERENCE TO RELATED APPLICATIONS

This application is a national phase application of International Application No. PCT/JP2008/071785, filed Dec. 1, 2008, the contents of which are incorporated herein by reference.

### TECHNICAL FIELD

The present invention relates to a solid electrolyte battery, a vehicle mounting it, a battery-mounting device, and a manufacturing method of the solid electrolyte battery.

### BACKGROUND ART

In recent years, there has been a growing demand for batteries used as power sources for portable devices such as a cell-phone, a notebook PC, and a video camcorder, and vehicles such as a hybrid electric vehicle and a plug-in hybrid electric vehicle.

One of those batteries is known as a solid electrolyte battery in which a solid electrolyte layer having lithium ion conductivity is interposed between a positive electrode and a negative electrode. For instance, Patent Literature 1 discloses an all solid battery (a solid electrolyte battery) composed so that a volatile content of a solid electrolyte layer is a predetermined amount or less, that is, 50 g or less per 1 kg of solid electrolyte.

### Citation List

### Patent Literature

Patent Literature 1: JP-2008-103145A

### SUMMARY OF INVENTION

### Technical Problem

However, in the solid electrolyte battery disclosed in Patent Literature 1, the solid electrolytes are bonded together with a resin binder to form the solid electrolyte layer. Accordingly, the resistance of the solid electrolyte layer tends to be higher due to the binder.

For manufacturing the solid electrolyte battery disclosed in Patent Literature 1, when the solid electrolyte layer is to be formed, the solid electrolyte is dispersed in a volatile dispersion medium (carrier fluid) to form slurry. Depending on dispersion medium, however, the solid electrolyte may be decomposed, leading to a decrease in lithium ion conductivity in the solid electrolyte layer.

The present invention has been made to solve the above problems and has a purpose to provide a solid electrolyte having a low-resistance solid electrolyte layer. Another purpose is to provide a vehicle mounting this solid electrolyte battery, a battery-mounting device, and a manufacturing method of the solid electrolyte battery.

### Solution to Problem

As a solution thereof, there is provided a solid electrolyte battery comprising: a positive active material layer containing positive active material particles; a negative active material layer containing negative active material particles; and a solid electrolyte layer interposed between the positive active material layer and the negative active material layer, wherein the solid electrolyte layer contains a sulfide solid electrolyte but no resin binder, the solid electrolyte layer self-maintains its shape by a bonding force of the sulfide solid electrolyte, the solid electrolyte layer has a layer thickness of 50 μm or less and an area of 100 cm² or more.

In this solid electrolyte battery, the solid electrolyte layer contains the sulfide solid electrolyte but no resin binder. The sulfide solid electrolyte is soft and easily deformable and therefore particles of the sulfide solid electrolyte are integrally combined with each other even if containing no binder. By the bonding force of this sulfide solid electrolyte, the solid electrolyte layer can self-maintain its shape. Since the solid electrolyte layer contains no binder as above, the solid electrolyte battery can be achieved with low resistance in the solid electrolyte layer.

The solid electrolyte battery includes the thin and wide solid electrolyte layer having the layer thickness of 50 μm or less while having the area of 100 cm² or more. The solid electrolyte battery can be used appropriately as a high-power or high-capacity battery for e.g. a hybrid electric vehicle, a plug-in hybrid electric vehicle, and an electric vehicle.

The solid electrolyte battery may be configured to include a single set of the positive active material layer, the negative active material layer, and the solid electrolyte layer interposed therebetween or a plurality of sets thereof in laminated relation.

The sulfide solid electrolyte may include for example Li₂S—P₂S₅ glass (80 Li₂S-20 P₂S₅ made of a mixture at a mole ratio of Li₂S:P₂S₅=80:20, etc.), Li₂S—SiS₂ glass, Li₂S—SiS₂—P₂S₅—LiI glass, Li₂S—SiS₂—Li₄SiO₄ glass, Li₄GeS₄—Li₃PS₄ glass, and crystallized glass of any one of those glasses.

Furthermore, in the above solid electrolyte battery, preferably, the positive active material layer contains the sulfide solid electrolyte but no resin binder, the positive active material particles are bonded together by the sulfide solid electrolyte and the positive active material layer self-maintains its shape by bonding force of the sulfide solid electrolyte, the positive active material layer has a layer thickness of 100 μm or less and an area of 100 cm² or more, and the negative active material layer contains the sulfide solid electrolyte but no resin binder, the negative active material particles are bonded together through the sulfide solid electrolyte and the negative active material layer self-maintains its shape by the bonding force of the sulfide solid electrolyte, the negative active material layer has a layer thickness of 100 μm or less and an area of 100 cm² or more.

In this solid electrolyte battery, the positive active material layer also contains the sulfide solid electrolyte but no binder. The positive active material particles are bonded together through this sulfide solid electrolyte. By the bonding force of this sulfide solid electrolyte, the positive active material layer can maintain its shape. Accordingly, the positive active material layer can also be made low in resistance as well as the solid electrolyte layer, and hence the solid electrolyte battery can be achieved with low internal resistance.

On the negative electrode side, similarly, the negative active material layer contains the sulfide solid electrolyte but no binder. The negative active material particles are bonded together through this sulfide solid electrolyte. By bonding force of this sulfide solid electrolyte, the negative active material layer can maintain its shape. Accordingly, the negative active material layer can also be made low in resistance, and hence the solid electrolyte battery can therefore be achieved with lower internal resistance.

As above, the solid electrolyte battery having low internal resistance can be manufactured because of low resistance of both of the positive active material layer and the negative active material layer.

The solid electrolyte battery includes the positive active material layer and the negative active material layer, each being made thin and wide with the layer thickness of 100 μm or less but with the area of 100 cm² or more. The solid electrolyte battery can be appropriately used as a high-power or high-capacity battery for e.g. a hybrid electric vehicle, a plug-in hybrid vehicle, and an electric vehicle.

Furthermore, another aspect is a solid electrolyte battery comprising: a positive active material layer containing positive active material particles; a negative active material layer containing negative active material particles; and a solid electrolyte layer interposed between the positive active material layer and the negative active material layer, wherein the solid electrolyte layer contains a sulfide solid electrolyte but no resin binder, the solid electrolyte layer is formed by depositing electrolyte particles made of the sulfide solid electrolyte by use of an electrostatic screen printing method and compressing the deposited particles in a layer thickness direction, and the solid electrolyte layer self-maintains its shape by a bonding force of the sulfide solid electrolyte.

Meanwhile, an electrostatic screen printing method has been known as a technique for depositing particles to form a coating film on a substrate (or on a coating film formed in advance on the substrate). The electrostatic screen printing method is achieved by applying high voltage (e.g., 500 V or more) between a mesh screen and a coating surface of the substrate to generate an electrostatic field, feeding charged particles into the electrostatic field through mesh openings of the mesh screen to cause the particles to fly toward the coating surface by a Coulomb's force, thereby depositing (coating) the particles on the coating surface.

In this solid electrolyte battery, the solid electrolyte layer is formed by use of the aforementioned electrostatic screen printing method. Since no dispersion medium is used for forming the solid electrolyte layer, the sulfide solid electrolyte is not decomposed by the dispersion medium. Accordingly, the solid electrolyte battery can be produced with the solid electrolyte layer configured to prevent a decrease in lithium ion conductivity.

Furthermore, the sulfide solid electrolyte is soft and easily deformable and hence particles of the sulfide solid electrolyte can be integrally combined together even if using no binder. By the bonding force of the sulfide solid electrolyte, the solid electrolyte layer can maintain its shape by itself. Since no binder is contained in the solid electrolyte layer, the solid electrolyte battery can be manufactured with the solid electrolyte layer having low resistance.

In the above solid electrolyte battery, preferably, the positive active material layer contains the sulfide solid electrolyte but no resin binder, the positive active material layer is formed by depositing first mixed particles of the positive active material particles and the electrolyte particles by use of an electrostatic screen printing method, and compressing the deposited particles in the layer thickness direction, the positive active material particles are bonded together through the sulfide solid electrolyte and the positive active material layer self-maintains its shape by the bonding force of the sulfide solid electrolyte, the negative active material layer contains the sulfide solid electrolyte but no resin binder, the negative active material layer is formed by depositing second mixed particles of the negative active material particles and the electrolyte particles by use of an electrostatic screen printing method, and compressing the deposited particles in the layer thickness direction, and the negative active material particles are bonded together through the sulfide solid electrolyte and the negative active material layer self-maintains its shape by the bonding force of the sulfide solid electrolyte.

In this solid electrolyte battery, the positive active material layer and the negative active material layer as well as the solid electrolyte layer are also formed by the electrostatic screen printing method. In other words, the positive active material layer is formed from the first mixed particles without using the dispersion medium, and hence the sulfide solid electrolyte is not decomposed by the dispersion medium. Similarly, also in the negative active material layer, the sulfide solid electrolyte is not decomposed by the dispersion medium.

Accordingly, the solid electrolyte battery can be produced with the positive active material layer and the negative active material layer as well as the solid electrolyte layer, each being configured to prevent a decrease in lithium ion conductivity.

Furthermore, the battery includes the positive active material layer in which the positive active material particles are bonded together through the sulfide solid electrolyte, so that the positive active material layer maintains its shape by the bonding force of the sulfide solid electrolyte. On the negative side, similarly, the negative active material layer contains the sulfide solid electrolyte but no binder, the negative active material particles are bonded together through the sulfide solid electrolyte, and the negative active material layer maintains its shape by the bonding force of this sulfide solid electrolyte. Consequently, both of the positive active material layer and the negative active material layer can be made low in resistance and hence the battery with low internal resistance can be realized.

In one of the above solid electrolyte batteries, preferably, the solid electrolyte layer is formed on a precedingly-formed active material layer formed on a conductive electrode plate, the precedingly-formed active material layer being is one of the positive active material layer and the negative active material layer, and also the solid electrolyte layer is formed on a peripheral portion of the electrode plate around the precedingly-formed active material layer so that the solid electrolyte layer covers over the precedingly-formed active material layer.

In the solid electrolyte battery of the present invention, the solid electrolyte layer is formed to cover over the precedingly-formed active material layer. This makes it possible to prevent the active material layer constituting the precedingly-formed active material layer from directly contacting with the active material layer of a different pole therefrom, thus preventing a short circuit therebetween.

Furthermore, another aspect is a vehicle mounting one of the aforementioned solid electrolyte batteries.

This vehicle mounts any one of the aforementioned solid electrolyte batteries and therefore the vehicle can provide high power and have good running performance.

The vehicle may be any vehicle if only it uses electrical energy of a battery as the entire or a part of a power source. For example, the vehicle may include an electric vehicle, a hybrid electric vehicle, a plug-in hybrid vehicle, a hybrid railroad vehicle, a fork lift, an electric wheel chair, an electric assisting bicycle, and an electric scooter.

Furthermore, another aspect is a battery-mounting device mounting one of the aforementioned solid electrolyte batteries.

This battery-mounting device mounts any one of the aforementioned solid electrolyte batteries and therefore can be achieved as a battery-mounting device providing high power and having good characteristics.

The battery-mounting device may be any device if only it mounts a battery and utilizes the battery as at least one of energy sources. For example, the battery-mounting device may include various home electric appliances, office equipment, and industrial equipment, which are driven by batteries, such as a personal computer, a cell-phone, a battery-driven electric tool, an uninterruptible power supply system.

Furthermore, another aspect is a manufacturing method of a solid electrolyte battery, the solid electrolyte battery comprising: a positive active material layer containing positive active material particles; a negative active material layer containing negative active material particles; and a solid electrolyte layer interposed between the positive active material layer and the negative active material layer, wherein the solid electrolyte layer contains a sulfide solid electrolyte but no resin binder, the method comprises: an electrolyte deposition process for depositing electrolyte particles made of the sulfide solid electrolyte by an electrostatic screen printing method to form an uncompressed solid electrolyte layer; and an electrolyte compression process for compressing the uncompressed solid electrolyte layer in a layer thickness direction to form the solid electrolyte layer that self-maintains its shape by a bonding force of the sulfide solid electrolyte.

The manufacturing method of the solid electrolyte battery includes the above electrolyte deposition process and the electrolyte compression process to compress the uncompressed solid electrolyte layer containing no resin binder in the layer thickness direction, thereby forming the solid electrolyte layer that maintains its shape by the bonding force of the sulfide solid electrolyte. Since no binder is used, the solid electrolyte battery having the low-resistance solid electrolyte layer can be manufactured. In the electrolyte deposition process, the electrostatic screen printing method is used. This makes it possible to form the uncompressed solid electrolyte layer without using dispersion medium and therefore prevent the sulfide solid electrolyte from being decomposed by the dispersion medium. Consequently, the solid electrolyte battery with the solid electrolyte layer configured to prevent a decrease in lithium ion conductivity can be manufactured.

In the above solid electrolyte battery, preferably, the positive active material layer contains a sulfide solid electrolyte but no resin binder, the negative active material layer contains a sulfide solid electrolyte but no resin binder, the method comprises: a positive active material deposition process for depositing first mixed particles of the positive active material particles and the electrolyte particles to form an uncompressed positive active material layer by an electrostatic screen printing method; a positive active material compression process for compressing the uncompressed positive active material layer in the layer thickness direction to bond the positive active material particles together through the sulfide solid electrolyte to thereby form the positive active material layer that self-maintains its shape by the bonding force of the sulfide solid electrolyte; a negative active material deposition process for depositing second mixed particles of the negative active material particles and the electrolyte particles to form an uncompressed negative active material layer by the electrostatic screen printing method; and a negative active material compression process for compressing the uncompressed negative active material layer in the layer thickness direction to bond the negative active material particles together through the sulfide solid electrolyte to thereby form the negative active material layer that self-maintains its shape by the bonding force of the sulfide solid electrolyte.

This manufacturing method of the solid electrolyte battery includes the positive active material deposition process and the positive active material compression process to form the positive active material layer that maintains its shape by the bonding force of the sulfide solid electrolyte even if containing no resin binder. Similarly, the method includes the negative active material deposition process and the negative active material compression process to form the negative active material layer that maintains its shape by the bonding force of the sulfide solid electrolyte even if containing no resin binder. As above, the positive active material layer and the negative active material layer contain no binder and thus the solid electrolyte battery provided with the positive active material layer and the negative active material layer each having low resistance can be produced.

Furthermore, the electrostatic screen printing method is used in the positive active material deposition process and hence the uncompressed positive active material layer can be formed without using dispersion medium. The electrostatic screen printing method is also used in the negative active material deposition process, so that the uncompressed negative active material layer can be formed without using dispersion medium. Accordingly, in the uncompressed positive active material layer and the uncompressed negative active material layer, the sulfide solid electrolyte is not decomposed by dispersion medium. Consequently, the solid electrolyte battery can be manufactured with the positive active material layer and the negative active material layer each configured to prevent a decrease in lithium ion conductivity.

In one of the above solid electrolyte manufacturing methods preferably, the electrolyte deposition process includes forming the uncompressed solid electrolyte layer by depositing the electrolyte particles on a precedingly-formed active material layer formed on a conductive electrode plate, the precedingly-formed active material layer being one of the positive active material layer and the negative active material layer and also on a peripheral portion the electrode plate located around the precedingly-formed active material layer to cover over the precedingly-formed active material layer.

In this manufacturing method of the solid electrolyte battery, the uncompressed solid electrolyte layer is formed to cover over the precedingly-formed active material layer. This prevents the positive active material layer (or the negative active material layer) constituting the precedingly-formed active material layer from directly contacting with the negative active material layer (or the positive active material layer) of a different pole therefrom. Thus, the solid electrolyte battery can be manufactured in which a short circuit between the positive active material layer and the negative active material layer is prevented.

Alternatively, in one of the above solid electrolyte manufacturing methods, preferably, the electrolyte deposition process includes forming the uncompressed solid electrolyte layer by depositing the electrolyte particles on a precedingly-formed uncompressed active material layer formed on a conductive electrode plate, the precedingly-formed uncompressed active material layer being one of the uncompressed positive active material layer and the uncompressed negative active material layer, and also on a peripheral portion of the electrode plate located around the precedingly-formed active material layer to cover over the precedingly-formed active material layer.

In this manufacturing method of the solid electrolyte battery, the uncompressed solid electrolyte layer is formed to cover over the precedingly-formed uncompressed active material layer. This prevents the positive active material layer (or the negative active material layer) formed by compression of the uncompressed positive active material layer (or the uncompressed negative active material layer) constituting the precedingly-formed uncompressed active material layer from directly contacting with the negative active material layer (or the positive active material layer) formed by compression of the uncompressed negative active material layer (or the uncompressed positive active material layer) of a different pole therefrom. Thus, the solid electrolyte battery can be produced in which a short circuit therebetween is prevented.

Furthermore, in one of the above solid electrolyte manufacturing methods, preferably, the electrolyte deposition process includes depositing the electrolyte particles thicker on the peripheral portion of the electrode plate than on the precedingly-formed active material layer or the precedingly-formed uncompressed active material layer.

In the electrolyte deposition process, when the electrolyte particles are deposited evenly in the layer thickness direction on for example the precedingly-formed active material layer (or the precedingly-formed uncompressed active material layer) and on the peripheral portion around the active material layer, the upper surface of the formed, uncompressed solid electrolyte layer is shaped in a stepped form, i.e., high on the precedingly-formed active material layer (the precedingly-formed uncompressed active material layer) and low on the peripheral portion.

In the solid electrolyte compression process, for example, when the stepped uncompressed solid electrolyte layer is compressed, the uncompressed solid electrolyte solid electrolyte layer on the peripheral portion may be insufficiently compressed.

On the other hand, in the above solid electrolyte battery manufacturing method, in the electrolyte deposition process, the electrolyte particles are deposited thicker on the peripheral portions than on the precedingly-formed active material layer (or the precedingly-formed uncompressed active material layer). This makes it possible to manufacture the solid electrolyte battery by appropriately compressing any portions of the uncompressed solid electrolyte layer in the layer thickness direction.

In the above solid electrolyte manufacturing method, preferably, the electrolyte deposition process is performed by use of a mesh screen including a first screen part located corresponding to the precedingly-formed active material layer or the precedingly-formed uncompressed active material layer and a second screen part located corresponding to the peripheral portion around the active material layer, the second screen part having a larger mesh opening size than that of the first screen part.

In this manufacturing method of the solid electrolyte battery, the electrolyte particles are deposited by the electrostatic screen printing method using the aforementioned mesh screen. Therefore, the uncompressed solid electrolyte layer can be reliably thicker and efficiently deposited on the peripheral portion around the active material layer than on the precedingly-formed active material layer (or the precedingly-formed uncompressed active material layer).

In the above solid electrolyte manufacturing method, preferably, one of the positive active material deposition process and the negative active material deposition process is performed as a preceding active material deposition process prior to the electrolyte deposition process, the other of the positive active material deposition process and the negative active material deposition process is performed as a succeeding active material deposition process after the electrolyte deposition process, the electrolyte compression process, the positive active material compression process, and the negative active material compression process are simultaneously performed after the succeeding active material deposition process, and the uncompressed solid electrolyte layer, the uncompressed positive active material layer, and the uncompressed negative active material layer are simultaneously compressed to form the solid electrolyte layer, the positive active material layer, and negative active material layer.

In this manufacturing method of the solid electrolyte battery, the preceding active material deposition process, the electrolyte deposition process, and the succeeding active material deposition process are performed in this order, and then the electrolyte compression process, the positive active material compression process, and the negative active material compression process are performed simultaneously. Consequently, compressing three layers at the same time as above can manufacture the solid electrolyte battery efficiently formed with the solid electrolyte layer, positive active material layer, and negative active material layer.

### BRIEF DESCRIPTION OF DRAWINGS

FIG. 1 is a perspective view of a battery in first, second, third, and fourth embodiments and a first modified example;

FIG. 2 is a partly sectional view of the battery in the first, second, and third embodiments and first modified example;

FIG. 3 is a perspective view of a power generation element in the first, second, and third embodiments;

FIG. 4 is a partly enlarged sectional view (along a line A-A in FIG. 3) of the power generation element in the first and second embodiments;

FIG. 5 is an explanatory view of a deposition process and a compression process in the first, third, and fourth embodiments, and first modified example;

FIG. 6A is an explanatory view of the deposition process in the first, second, third, and fourth embodiments, and first modified example;

FIG. 6B is an explanatory view of the deposition process in the first, second, third, and fourth embodiments, and first modified example;

FIG. 7 is an explanatory view of an uncompressed positive active material layer in the first, second, third, and fourth embodiments, and first modified example;

FIG. 8 is an explanatory view of a positive active material layer in the first, second, third, and fourth embodiments, and first modified example;

FIG. 9 is an explanatory view of the positive active material layer and a solid electrolyte layer in the first and fourth embodiments;

FIG. 10 is an explanatory view of the positive active material layer, solid electrolyte layer, and negative active material layer in the first, second, and fourth embodiments;

FIG. 11 is an explanatory view of the deposition process and a three-layer simultaneous compression process in the second embodiment;

FIG. 12 is an explanatory view of an uncompressed positive active material layer and an uncompressed solid electrolyte layer in the second embodiment;

FIG. 13 is an explanatory view of the uncompressed positive active material layer, uncompressed solid electrolyte layer, and uncompressed negative active material layer in the second embodiment;

FIG. 14 is a partly enlarged sectional view (along the line A-A in FIG. 3) of the power generation element in the third embodiment;

FIG. 15 is an explanatory view of a manufacturing process of the battery in the third embodiment;

FIG. 16 is an explanatory view of the deposition process in the third embodiment;

FIG. 17 is an explanatory view of the positive active material layer and the solid electrolyte layer in the third embodiment;

FIG. 18 is an explanatory view of the positive active material layer, solid electrolyte layer, and negative active material layer in the third embodiment;

FIG. 19 is a partly sectional view of the battery in the fourth embodiment;

FIG. 20 is a perspective view of the power generation element in the fourth embodiment;

FIG. 21 is a partly enlarged sectional view (along a line B-B in FIG. 20) of the power generation element in the fourth embodiment;

FIG. 22 is an explanatory view of the uncompressed positive active material layer and the uncompressed solid electrolyte layer in the first embodiment;

FIG. 23 is an explanatory view of a vehicle in the fifth embodiment;

FIG. 24 is an explanatory view of a hammer drill in the sixth embodiment;

FIG. 25 is an explanatory view of a die used in another embodiment; and

FIG. 26 is an explanatory view of a compressed solid electrolyte layer used in the embodiment shown in FIG. 25.

### REFERENCE SIGNS LIST

1, 301, 401, 501, 601 Battery (Solid electrolyte battery)
21 Positive active material layer (Precedingly-formed active material layer)
21B Uncompressed positive active material layer (Precedingly-formed uncompressed active material layer)
21S Area (of positive active material layer)
21T Layer thickness (of positive active material layer)
22 Positive active material particles
26 Positive electrode substrate (Electrode substrate)
26E Peripheral portion (Peripheral portion of active material layer)
31 Negative active material layer
31B Uncompressed negative active material layer
31S Area (of negative active material layer)
31T Layer thickness (of negative active material layer)
32 Negative active material particles
36 Negative electrode substrate (Electrode substrate)
36E Peripheral portion (Peripheral portion of active material layer)
40, 440, 940 Solid electrolyte layer
40B, 440B Uncompressed solid electrolyte layer
40S, 440S Area (of solid electrolyte layer)
40T, 440T Layer thickness (of solid electrolyte layer)
110K Screen (Mesh screen)
111 First screen part
112 Second screen part
551 Total positive electrode substrate (Electrode substrate)
556 Total negative electrode substrate (Electrode substrate)
566 Electrode substrate
700 Vehicle
710 Assembled battery (Battery)
800 Hammer drill (Battery-mounting device)
810 Battery pack (Battery)
DT Layer thickness direction
MX1 First mixed particles (First mixed particles)
MX2 Second mixed particles (Second mixed particles)
SE Sulfide solid electrolyte
SP Electrolyte particles

### DESCRIPTION OF EMBODIMENTS

### First Embodiment

A detailed description of a first embodiment of the present invention will now be given referring to the accompanying drawings.

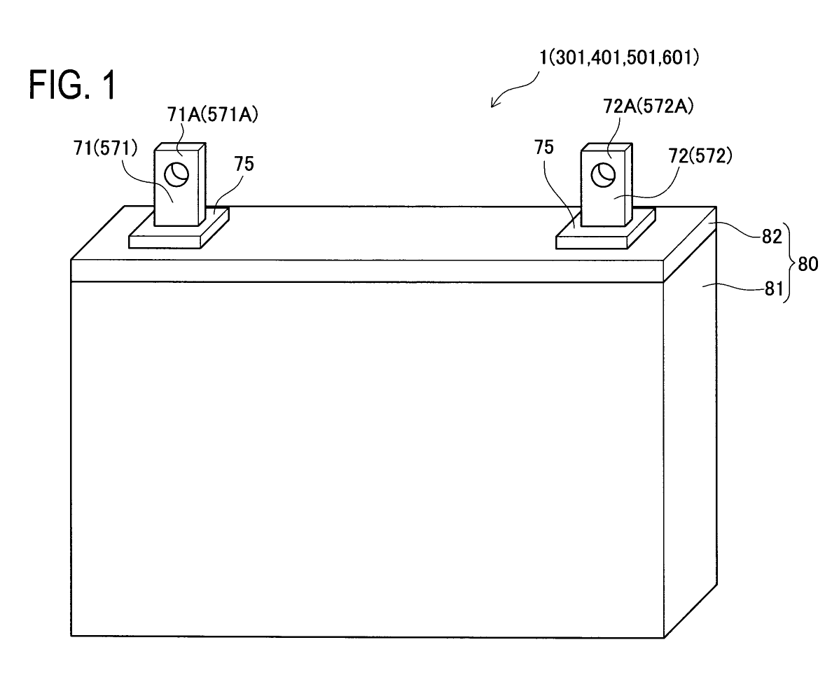

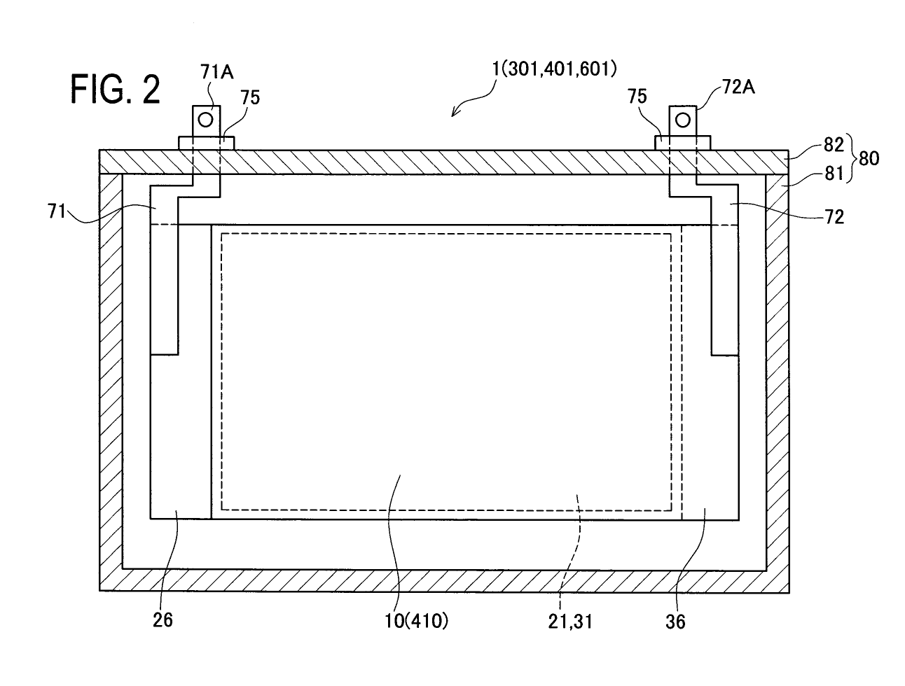

FIG. 1 is a perspective view of a solid electrolyte 1 (hereinafter, simply referred to as a battery) in the first embodiment and FIG. 2 is a partly sectional view of this battery 1.

This battery 1 is a lithium ion secondary battery having a battery case 80 and a power generation element 10 housed in this battery case 80 (see FIGS. 1 and 2).

The battery case 80 includes a battery case body 81 made of metal in a bottom-closed rectangular box shape having an upper opening, and a closing lid 82 made of a metal sheet for closing the opening of the case body 81 (see FIG. 1).

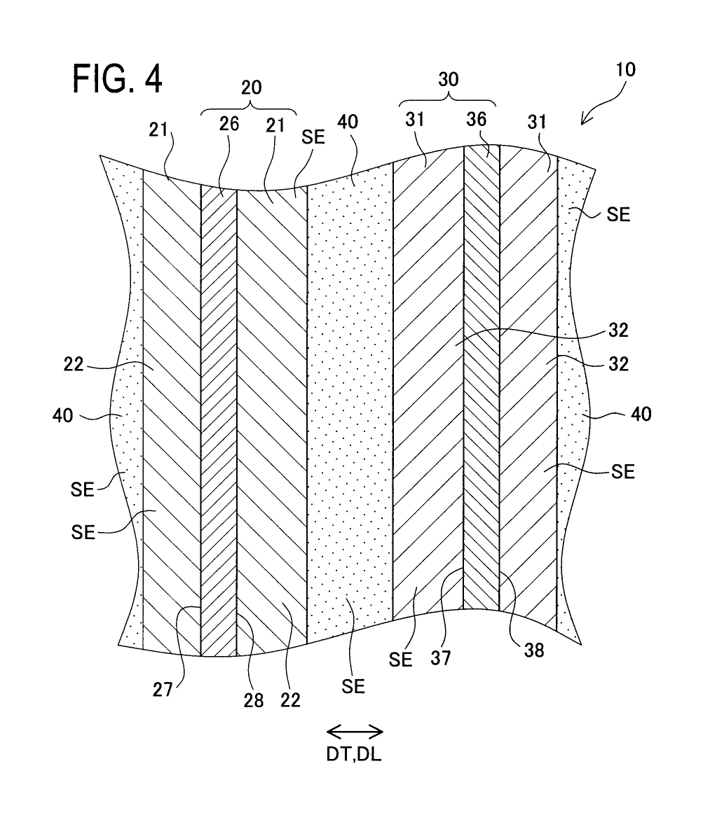

From the closing lid 82, a leading end 71A of a positive current collector 71 made of aluminum and electrically connected to a positive electrode plate 20 of the power generation element 10 and a leading end 72A of a negative current collector 72 made of copper and electrically connected to a negative electrode plates 30 of the power generation element 10 protrude respectively (see FIGS. 1 and 4). An insulation member 75 made of insulating resin is interposed between the closing lid 82 and the positive current collector 71 or the negative current collector 72, thereby insulating between the closing lid 82 and the positive current collector 71 or the negative current collector 72.

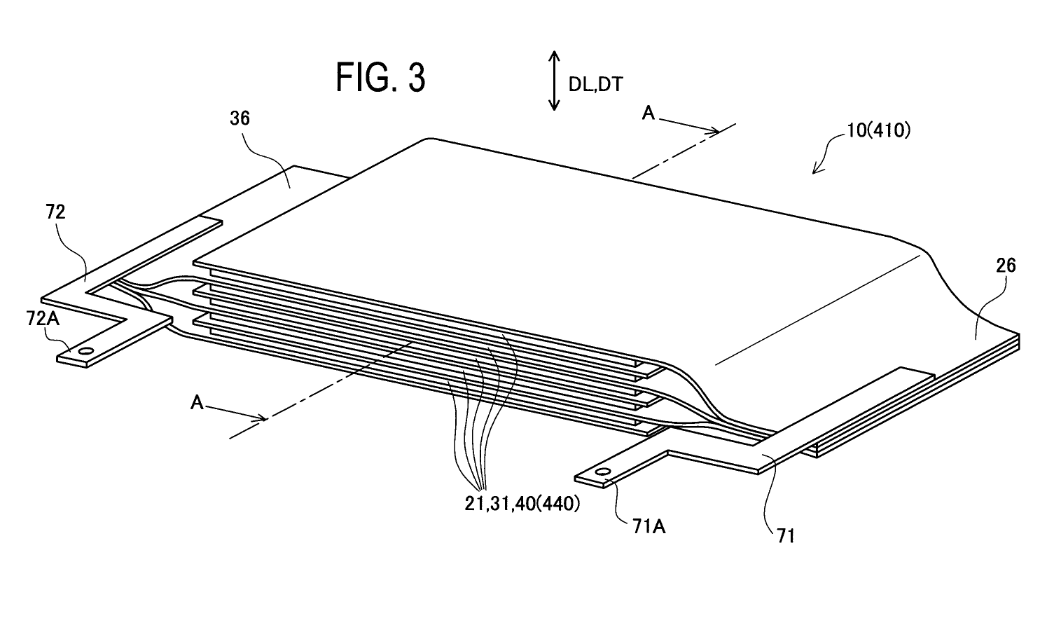

The power generation element 10 is arranged such that a plurality of positive electrode plates 20 and a plurality of negative electrode plates 30 are alternately laminated in a lamination direction DL (see FIGS. 3 and 4). Each positive electrode plate 20 includes a positive electrode substrate 26 made of an aluminum foil and positive active material layers 21 formed on the positive electrode substrate 26. Each negative electrode plate 30 includes a negative electrode substrate 36 made of a copper foil and negative active material layers 31 formed on the negative electrode substrate 36. Furthermore, a solid electrolyte layer 40 is interposed between the positive active material layer 21 of the positive electrode plate 20 and the negative active material layer 31 of the negative electrode plate 30 adjacent to this positive electrode plate 20 (see FIG. 4).

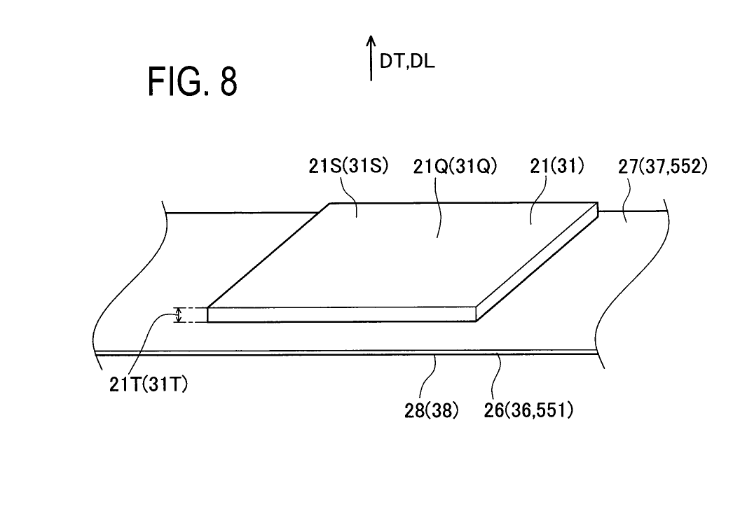

Specifically, the positive electrode plate 20 is provided, on a first principal surface 27 and a second principal surface 28 which are both sides of the positive electrode substrate 26, respectively with the positive active material layers 21 containing positive active material particles 22 made of lithium cobalt oxide (LiCoO₂) and a sulfide solid electrolyte SE made of Li₂S—P₂S₅ glass (80 Li₂S-20 P₂S₅ made of a mixture at a mole ratio of Li₂S:P₂S₅=80:20) (see FIG. 4). In first embodiment, a volume ratio of them in the positive active material layer 21 is determined to “positive active material particles 22:sulfide solid electrolyte SE”=6:4. This positive active material layer 21 is of a rectangular plate shape as shown in FIG. 8, in which a layer thickness 21T in the lamination direction DL is 30 μm and an area 21S of a positive electrode layer principal surface 21Q facing to this lamination direction DL is 180 cm².

The negative electrode plate 30 is specifically provided, on a first principal surface 37 and a second principal surface 38 which are both sides of the negative electrode substrate 36, respectively with the negative active material layers 31 containing negative active material particles 32 made of graphite and the sulfide solid electrolyte SE (see FIG. 4).

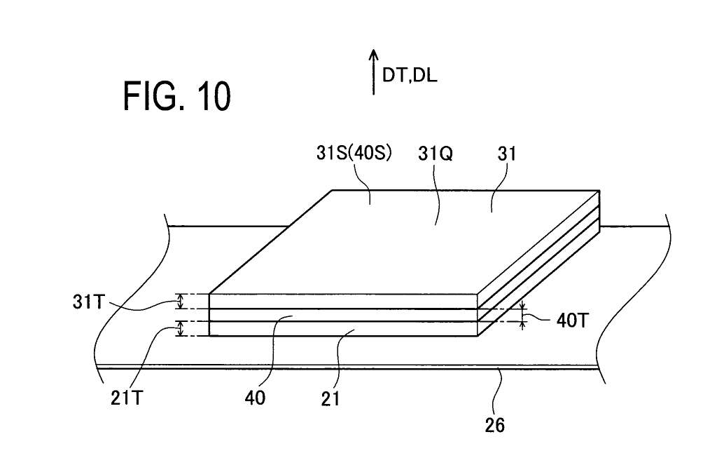

A volume ratio thereof in this negative active material layer 31 is determined to “negative active material particles 32:sulfide solid electrolyte SE”=6:4. This negative active material layer 31 is of a rectangular plate shape as shown in FIG. 10, in which a layer thickness 31T in the lamination direction DL is 35 μm and an area 31S of a negative electrode layer principal surface 31Q facing to this lamination direction DL is 180 cm².

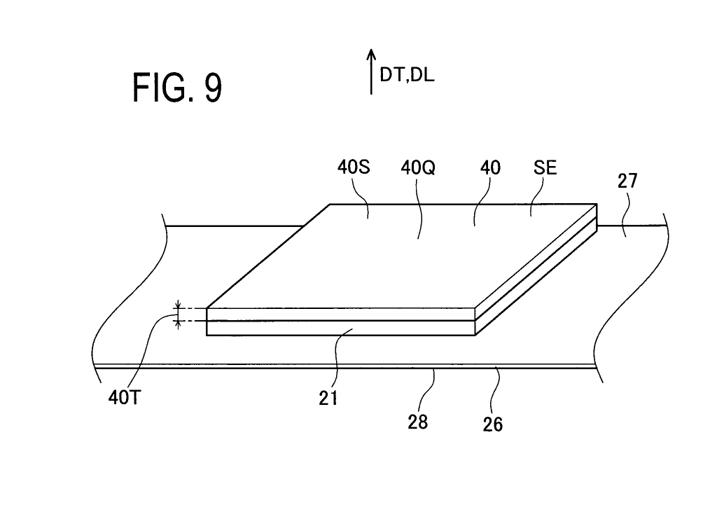

The solid electrolyte layer 40 is made of the sulfide solid electrolyte SE (see FIG. 4). This solid electrolyte layer 40 is of a rectangular plate shape as shown in FIG. 9, in which a layer thickness 40T in the lamination direction DL is 30 μm and an area 40S of a solid layer principal surface 40Q facing to this lamination direction DL is 180 cm².

In the battery 1 in this embodiment 1, the solid electrolyte layer 40 contains the sulfide solid electrolyte SE but does not contain a resin binder. This sulfide solid electrolyte SE is soft and easily deformable. Accordingly, even if using no binder, particles of the sulfide solid electrolyte SE are integrally bonded to each other. By this bonding force of the sulfide solid electrolyte SE, the solid electrolyte layer 40 can maintain its shape by itself. Since the solid electrolyte layer 40 contains no binder, the battery 1 can be produced with the low-resistance solid electrolyte layer 40.

The battery 1 includes the positive active material layer 21 that contains the sulfide solid electrolyte SE but no binder. Thus, the positive active material particles 22 are bonded to each other through this sulfide solid electrolyte SE and hence the positive active material layer can maintain its shape by the bonding force of the sulfide solid electrolyte SE. Accordingly, the positive active material layer 21 can also be made low in resistance as well as the solid electrolyte layer 40. The battery 1 can therefore be manufactured with lower internal resistance.

On the negative side, similarly, the battery 1 also includes the negative active material layer 31 that contains the sulfide solid electrolyte SE but no binder. Thus, the negative active material particles 32 are bonded to each other through this sulfide solid electrolyte SE and hence the negative active material layer 31 can maintain its shape by the bonding force of the sulfide solid electrolyte SE. Accordingly, the negative active material layer 31 can also be made low in resistance. The battery 1 can therefore be manufactured with lower internal resistance.

Furthermore, the battery 1 with low internal resistance can be achieved by both the positive active material layer 21 and the negative active material layer 31 each having low resistance.

In addition, the battery 1 is provided with the thin and wide solid electrolyte layer 40 having the thickness 40T of 30 μm thinner than 50 μm while having the area 40S of 180 cm² wider than 100 cm² and also the thin and wide positive active material layer 21 and negative active material layer 31 each having the thickness 21T or 31T of 30 μm and 35 μm respectively thinner than 100 μm while having the area 21S or 31S of 180 cm² wider than 100 cm². Therefore, the battery 1 can be used suitably as for example a high-power or high-capacity battery for a hybrid electric vehicle, a plug-in hybrid electric vehicle, and an electric vehicle.

In the battery 1 in the first embodiment, the solid electrolyte layer 40 is made by use of an electrostatic screen printing method using no dispersion medium as mentioned later. Thus, the sulfide solid electrolyte SE is not be decomposed by the dispersion medium. This makes it possible to produce the battery 1 configured to prevent a decrease in lithium ion conductivity in the solid electrolyte layer 40.

As with the solid electrolyte layer 40, the positive active material layer 21 and the negative active material layer 31 are also made by the electrostatic screen printing method using no dispersion medium. Thus, the sulfide solid electrolyte SE in the positive active material layer 21 and in the negative active material layer 31 will not be decomposed by dispersion medium.

Accordingly, the battery 1 can be configured to prevent a decrease in lithium ion conductivity in not only the solid electrolyte layer 40 but also in the positive active material layer 21 and the negative active material layer 31.

A method of manufacturing the battery 1 in the first embodiment will be explained referring to accompanying drawings.

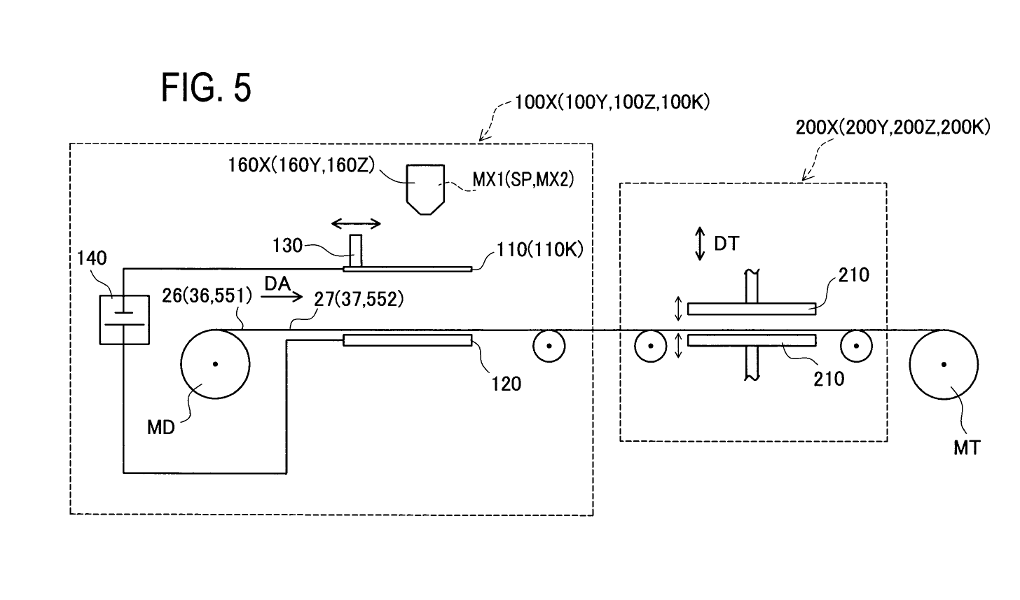

A positive active material deposition process to form an uncompressed positive active material layer 21B is first explained with reference to FIGS. 5 to 7.

A deposition device 100X used in the positive active material deposition process includes as shown in FIG. 5 a screen 110 made of stainless steel in a rectangular flat plate shape having 500 meshes (not shown) in a predetermined pattern, a table 120 made of stainless steel in a rectangular flat plate shape, a brush 130, a power source 140, and a supply unit 160X for supplying first mixed particles MX1 onto the screen 110 (upper in FIG. 5). The supply unit 160X stores therein the first mixed particles MX1 to supply the first mixed particles MX1 onto the screen 110.

The power source 140 applies voltage between the screen 110 and the table 120 located facing this screen 110. Specifically, a negative electrode of the power source 140 is connected to the screen 110 and a positive electrode thereof is connected to the table 120 respectively and a voltage of 3 kV is applied therebetween. This can generate an electrostatic field between the screen 110 and the table 120.

The brush 130 is placed on the screen 110 (upper in FIG. 5) to be movable (i.e., reciprocable right and left in FIG. 5) on the screen 110, thereby causing the electrically charged first mixed particles MX1 on the screen 110 to pass through mesh openings of the screen 110 and fly to (downward in FIG. 5) the table 120.

The screen 110 has 500 meshes in a predetermined pattern for depositing electrolyte particles SP on a desired place on the positive electrode substrate 26 to form the uncompressed positive active material layer 21B of a flat rectangular shape.

A positive active material deposition process is explained below.

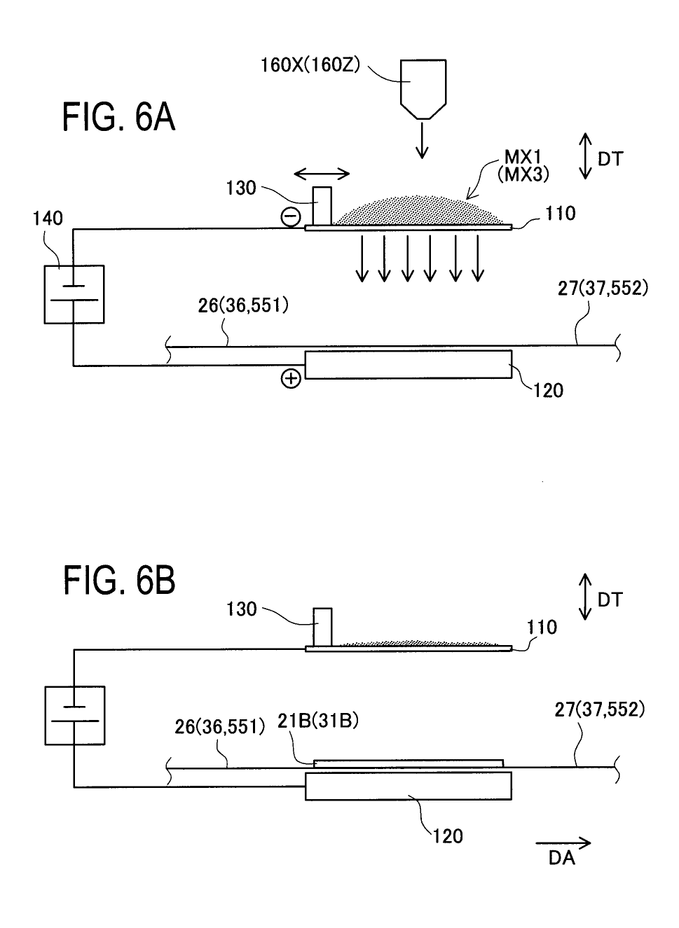

The strip-shaped positive electrode substrate 26 set in an unreeling section MD is intermittently unreeled to move in a longitudinal direction DA so that the first mixed particles MX1 are deposited on the first principal surface 27 of the positive electrode substrate 26 at predetermined intervals in the longitudinal direction DA (see FIG. 6A).

The first mixed particles MX1 contain the positive active material particles 22 and the electrolyte particles SP as a particle form of the sulfide solid electrolyte SE, which have been sufficiently mixed.

The first mixed particles MX1 supplied from the supply unit 160X to the screen 110 (upper in FIG. 6A) are charged to negative by friction between the brush 130 and the screen 110. The negative charged first mixed particles MX1 are pushed through the mesh openings of the screen 110.

Meanwhile, the power source 140 generates an electrostatic field between the screen 110 and the table 120 located below the power source 140 in FIG. 6A. Accordingly, the first mixed particles MX1 having passed through the mesh openings of the screen 110 are accelerated toward the table 120 by this electrostatic field and then collides with the positive electrode substrate 26 located above the table 120 in FIG. 6B.

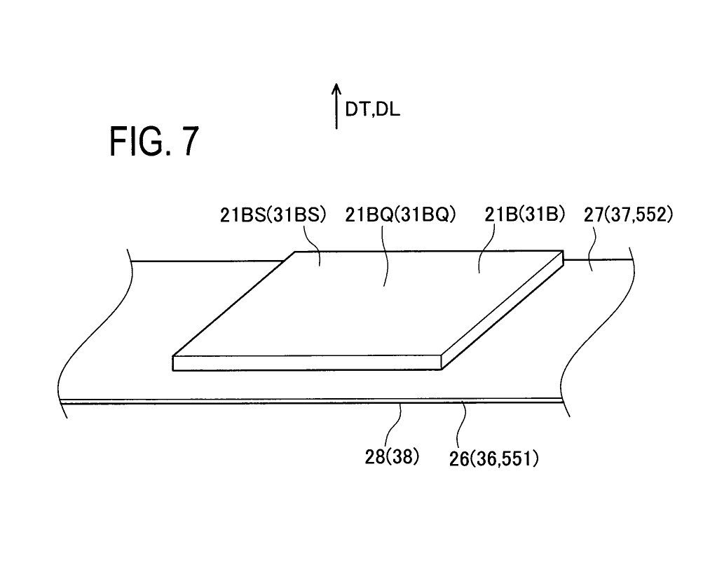

In this way, the first mixed particles MX1 are deposited on the first principal surface 27 of the positive electrode substrate 26, thereby forming the uncompressed positive active material layer 21B of a flat rectangular plate shape having an area of 180 cm² (see FIGS. 6B and 7).

Next, a positive active material compression process is performed. In this process, a compression device 200X provided with two metallic press dies 210 is used (FIG. 5).

The positive electrode substrate 26 formed with the uncompressed positive active material layer 21B is moved in the longitudinal direction DA, and the uncompressed positive active material layer 21B is compressed in the layer thickness direction DT by use of the two press dies 210 each having a rectangular flat plate shape movable in the layer thickness direction DT. In this way, the positive active material particles 22 are bonded together through the electrolyte particles SP by the bonding force of the electrolyte particles SP, thereby forming the positive active material layer 21 maintaining its shape by itself. Specifically, on one side of the positive electrode substrate 26 (the first principal surface 27 side), the positive active material layers 21 are intermittently formed with the layer thickness 21T of 30 μm and the area 21S of 180 cm² (see FIG. 8).

After the positive active material compression process, the positive electrode substrate 26 is wound at a winding section MT (see FIG. 5).

Subsequently, an electrolyte deposition process for forming the uncompressed solid electrolyte layer 40B is explained referring to FIGS. 5 and 9.

A deposition device 100Y used in this electrolyte deposition process includes as shown in FIG. 5 a supply unit 160Y for supplying electrolyte particles SP onto the screen 110 (upper in FIG. 5) in addition to the screen 110 made of stainless steel in a rectangular flat plate shape having 500 meshes in a predetermined pattern, the table 120, the brush 130, and the power source 140 which are identical to those of the deposition device 100X used in the positive active material deposition process. It is to be noted that the supply unit 160Y stores the electrolyte particles SP for supplying the electrolyte particles SP onto the screen 110.

This electrolyte deposition process is similar to the aforementioned positive active material deposition process excepting that the electrolyte particles SP are deposited on the positive active material layer 21 formed on the positive electrode substrate 26 to have a rectangular shape equal to the positive active material layer 21 as shown in FIG. 8. Thus, the details thereof are omitted herein.

By this electrolyte deposition process, the uncompressed solid electrolyte layer 40B is formed of the electrolyte particles SP on the positive active material layer 21.

An electrolyte compression process is then performed. In this process, the compression device 200Y including two metallic press dies 210 is used (see FIG. 5).

The positive electrode substrate 26 is moved in the longitudinal direction DA, and the uncompressed solid electrolyte layer 40B is compressed in the layer compression direction DT by use of the two press dies 210 movable in the layer thickness direction DT, thereby forming the solid electrolyte layer 40 self-maintaining its shape by the bonding force of the electrolyte particles SP. Specifically, the solid electrolyte layer 40 is formed with the layer thickness 40T of 30 μm and the area 40S of 180 cm² (see FIG. 9).

A negative active material deposition process for forming the uncompressed negative active material layer 31B is explained referring to FIGS. 5, 9, and 10.

A deposition device 100Z used in this negative active material deposition process includes as shown in FIG. 5 a supply unit 160Z for supplying a second mixed particles MX2 onto the screen 110 (upper in FIG. 5) in addition to the screen 110 made of stainless steel in a rectangular flat plate shape having 500 meshes in a predetermined pattern, the table 120, the brush 130, and the power source 140 which are identical to those of the deposition device 100X. It is to be noted that the supply unit 160Z stores the second mixed particles MX2 for supplying the second mixed particles MX2 onto the screen 110. The second mixed particles MX2 are a mixture of the negative active material particles 32 and the electrolyte particles SP.

The negative active material deposition process is similar to the aforementioned positive active material deposition process excepting that the second mixed particles MX2 are deposited on the solid electrolyte layer 40 on the positive electrode substrate 26 so that the second mixed particles MX2 are formed in a rectangular shape equal to the positive active material layer 21 and the solid electrolyte layer 40 as shown in FIG. 9. The details of this process are therefore omitted herein.

By this negative active material deposition process, an uncompressed negative active material layer 31B made of the second mixed particles MX2 deposited on the solid electrolyte layer 40 is formed.

A negative active material compression process is then performed. In this process, a compression device 200Z including two metallic press dies 210 is used (see FIG. 5).

The positive electrode substrate 26 is moved in the longitudinal direction DA, and the uncompressed negative active material layer 31B is compressed in the layer thickness direction DT by use of the two press dies 210 movable in the layer thickness direction DT. Thus, the negative active material particles 32 are bonded together through the electrolyte particles SP by the bonding force of the electrolyte particles SP in the uncompressed negative active material layer 31B, thereby forming the negative active material layer 31 self-maintaining its shape. Specifically, the negative active material layer 31 is formed with the layer thickness 31T of 35 μm and the area 31S of 180 cm² (see FIG. 10).

After the above negative active material compression process, the negative electrode substrate 36 of a rectangular flat shape is placed on the negative active material layer 31 and pressed in the thickness direction DT to join the negative active material layer 31 to the negative electrode substrate 36.

As an alternative, the negative electrode substrate 36 may be placed on the uncompressed negative active material layer 31B and then pressed in the thickness direction DT together with the positive electrode substrate 26, the positive active material layer 21, the solid electrolyte layer 40, and the uncompressed negative active material layer 31B in the negative active material compression process, thereby joining the negative active material layer 31 to the negative electrode substrate 36.

Furthermore, the aforementioned deposition devices 100X, 100Y, and 100Z and compression devices 200X, 200Y, and 200Z are repeatedly operated to perform the positive active material deposition process, the positive active material compression process, the electrolyte deposition process, the electrolyte compression process, the negative active material deposition process, and the negative active material compression process to form a plurality of the positive active material layers 21, solid electrolyte layers 40, and negative active material layers 31. As above, the aforementioned power generation element 10, namely, the power generation element 10 including the electrode plates 20 each having the positive active material layer 21 on the positive electrode substrate 26, the electrode plates 30 each having the negative active material layer 31 on the negative electrode substrate 36, and the solid electrolyte layers 40 each interposed between the positive active material layer 21 and the negative active material layer 31 is formed (see FIGS. 3 and 4).

Furthermore, after the positive electrode substrate 26 is cut, the positive current collector 71 is joined to the positive electrode plate 20 (positive electrode substrate 26) of the power generation element 10 and the negative current collector 72 is joined to the negative electrode plate 30 (negative electrode substrate 36) respectively (see FIG. 3). Then, this power generation element 10 is inserted in the battery case body 81 and the closing lid 82 is welded to this case body 81 to seal the opening. Thus, the battery 1 is completed (see FIG. 1).

The manufacturing method of the battery 1 in the first embodiment includes the electrolyte deposition process and the electrolyte compression process mentioned above to compress the uncompressed solid electrolyte layer 40B including no resin binder in the thickness direction DT, thereby forming the solid electrolyte layer 40 self-maintaining its shape by the bonding force of the sulfide solid electrolyte SE.

Since the binder is not used in forming the solid electrolyte layer 40 as above, the battery 1 provided with the low-resistance solid electrolyte layer 40 can be manufactured. In the electrolyte deposition process using the electrostatic screen printing method, the solid electrolyte layer 40B can be formed without using dispersion medium. Therefore, the sulfide solid electrolyte SE is not decomposed by the dispersion medium. Accordingly, the battery 1 with the low-resistance solid electrolyte layer 40 can be manufactured.

The manufacturing method of the battery 1 in the first embodiment includes the positive active material deposition process and the positive active material compression process to form the positive active material layer 21 self-maintaining its shape by the bonding force of the sulfide solid electrolyte SE without containing resin binder. Similarly, the manufacturing method includes the negative active material deposition process and the negative active material compression process to form the negative active material layer 31 self-maintaining its shape by the bonding force of the sulfide solid electrolyte SE.

As above, since no binder is contained in the positive active material layer 21 and the negative active material layer 31, the battery 1 can be manufactured with the low-resistance positive active material layer 21 and the low-resistance negative active material layer 31.

Furthermore, in both the positive active material deposition process and the negative active material deposition process, the electrostatic screen printing method is adopted and hence the uncompressed positive active material layer 21B and the uncompressed negative active material layer 31B can be formed without using dispersion medium. In the uncompressed positive active material layer 21B and the uncompressed negative active material layer 31B, accordingly, the sulfide solid electrolyte SE is not decomposed by dispersion medium. The battery 1 configured to prevent a decrease in lithium ion conductivity in the positive active material layer 21 and the negative active material layer 31 can therefore be manufactured.

### Second Embodiment

Next, a battery 301 in a second embodiment will be explained with reference to FIGS. 1 to 4, 6 to 8, and 10 to 13.

In this second embodiment, the battery manufacturing method is similar to the aforementioned first embodiment excepting that the positive active material deposition process, the electrolyte deposition process, and the negative active material deposition process are performed in order and then the positive active material compression process, the electrolyte compression process, and the negative active material compression process are simultaneously performed (a three-layer simultaneous compression process is performed).

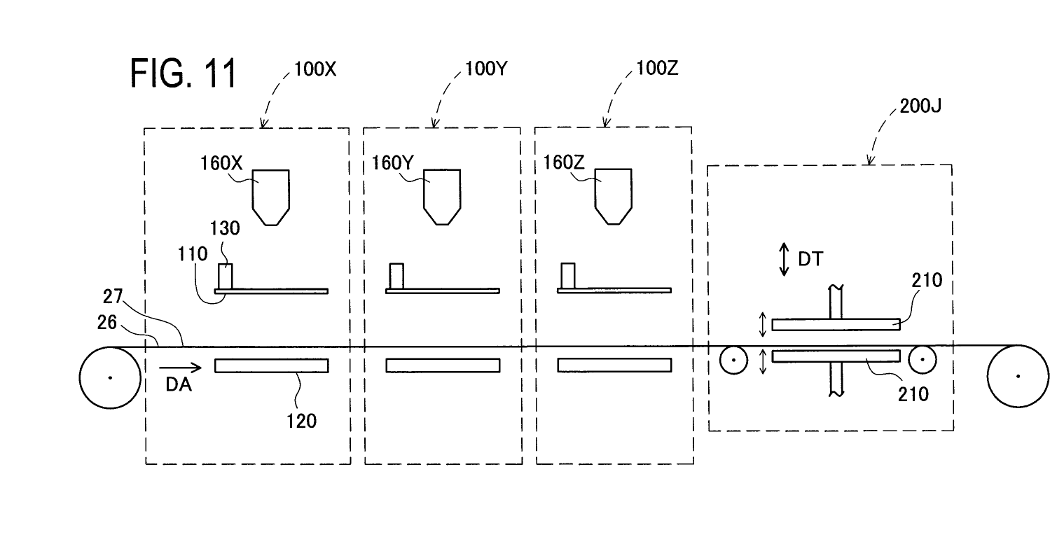

Specifically, in the manufacturing method of the battery 301 in this second embodiment, as shown in FIG. 11, as in the first embodiment, three deposition devices 100X, 100Y, and 100Z are arranged in this order in the longitudinal direction DA. The uncompressed positive active material layer 21B, the uncompressed solid electrolyte layer 40B, and the uncompressed negative active material layer 31B are formed in turn and then the three-layer simultaneous compression process is conducted to compress three layers at the same time by use of the compression device 200J.

To be concrete, as in the first embodiment, in the positive active material deposition process using the deposition device 100X, the first mixed particles MX1 are deposited on one side (the first principal surface 27 side) of the positive electrode substrate 26 to form the uncompressed positive active material layer 21B having an area 21BS of 180 cm² (see FIG. 7).

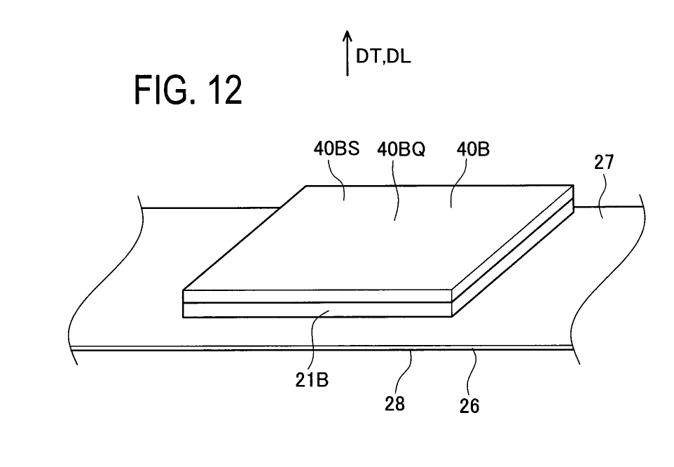

Subsequently, in the electrolyte deposition process using the deposition device 100Y the same as that in the first embodiment, the electrolyte particles SP are deposited on the uncompressed positive active material layer 21B to take a rectangular shape equal to the uncompressed positive active material layer 21B. Thus, the uncompressed solid electrolyte layer 40B made of the electrolyte particles SP and having an area 40BS of 180 cm² is formed on the uncompressed positive active material layer 21B (see FIG. 12).

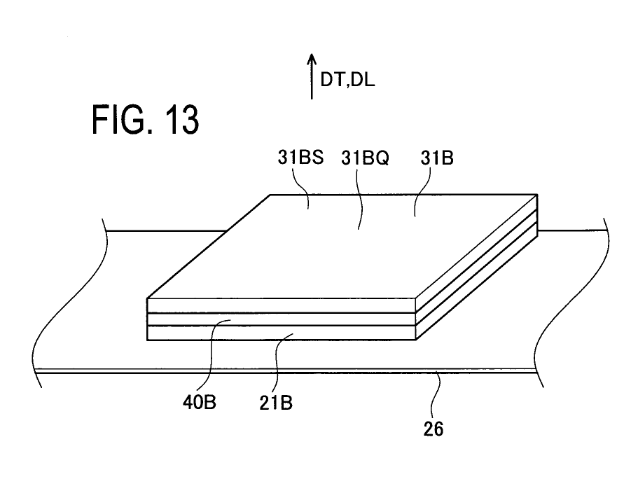

In the negative active material deposition process using the deposition device 100Z the same as that in the first embodiment, the second mixed particles MX2 are deposited on the uncompressed solid electrolyte layer 40B to take a rectangular shape equal to the uncompressed solid electrolyte layer 40B. Thus, the second mixed particles MX2 are deposited on the uncompressed solid electrolyte layer 40B to form the uncompressed negative active material layer 31B with the area 31BS of 180 cm² (see FIG. 13).

Then, the three-layer simultaneous compression process is performed. In this process, a compression device 200J including two metallic press dies 210 is used (see FIG. 11).

The positive electrode substrate 26 formed with the uncompressed positive active material layer 21B, the uncompressed solid electrolyte layer 40B, and the uncompressed negative active material layer 31B is moved in the longitudinal direction DA, and all of the uncompressed positive active material layer 21B, uncompressed solid electrolyte layer 40B, and uncompressed negative active material layer 31B are compressed in the thickness direction DT by use of the two press dies 210 movable in the thickness direction DT.

In this way, the positive active material particles 22 are bonded together through the electrolyte particles SP in the uncompressed positive active material layer 21B by the bonding force of the electrolyte particles SP, thereby forming the positive active material layer 21 self-maintaining its shape. Similarly, the negative active material particles 32 are bonded together through the electrolyte particles SP in the uncompressed negative active material layer 31B by the bonding force of the electrolyte particles SP, thereby forming the negative active material layer 31 self-maintaining its shape. Furthermore, the solid electrolyte layer 40 self-maintaining its shape by the bonding force of the electrolyte particles SP in the uncompressed solid electrolyte layer 40B is formed.

As above, on one side (the first principal surface 27 side) of the positive electrode substrate 26, the positive active material layer 21 having the thickness 21T of 30 μm, the solid electrolyte layer 40 having the thickness 40T of 30 μm, and the negative active material layer 31 having the thickness 31T of 35 μm are laminated (see FIG. 10).

In the above processes in the second embodiment, the positive active material deposition process corresponds to a preceding active material deposition process, and the negative active material deposition process corresponds to a succeeding active material deposition process, respectively.

In the manufacturing method of the battery 301 in the second embodiment, the positive active material deposition process, the electrolyte deposition process, and the negative active material deposition process are performed in order, and then the electrolyte compression process, the positive active material compression process, and the negative active material compression process are performed at the same time (the three-layer simultaneous compression process). By such simultaneous compression of three layers (uncompressed positive active material layer 21B, uncompressed solid electrolyte layer 40B, and uncompressed negative active material layer 31B), the battery 301 efficiently formed with the positive active material layer 21, solid electrolyte layer 40, and negative active material layer 31 can be manufactured.

After the above simultaneous compression process, the negative active material layer 31 is bonded to the negative electrode substrate 36 in the same manner as in the first produced.

Furthermore, in reverse to the above, the negative active material deposition process, the electrolyte deposition process, and the positive active material deposition process are performed in this order on the negative electrode substrate 36 and then the simultaneous compression process is conducted. Accordingly, the negative active material layer 31, the solid electrolyte layer 40, and the positive active material layer 21 are formed in this order on the negative electrode substrate 36.

As above, the positive active material deposition process, electrolyte deposition process, and negative active material deposition process mentioned above are repeated to laminate a plurality of the positive active material layers 21, the solid electrolyte layers 40, and negative active material layers 31 to produce the power generation element 10 (see FIGS. 3 and 4).

Thereafter, as in the first embodiment, after the positive electrode substrate 26 is cut, the positive current collector 71 is joined to the positive electrode plate 20 of the power generation element 10 and the negative current collector 72 is joined to the negative electrode plate 30 (see FIG. 3). This power generation element 10 is then inserted in the battery case body 81 and the closing lid 82 is welded to the case body 81 to seal the opening, thus completing the battery 301 (see FIGS. 1 and 2).

### Third Embodiment

A battery 401 in a third embodiment of the present invention will be explained referring to FIGS. 1 to 3, 5 to 8, and 14 to 18.

This third embodiment is similar to the aforementioned first embodiment excepting that this battery is configured such that each solid electrolyte layer covers over either of adjacent active material layers (a precedingly-formed active material layer mentioned later).

The following explanation is therefore focused on the differences from the first embodiment and the explanation of the similar parts or components is omitted or simplified. Similar parts or components to those in the first embodiment will provide the same operations and effects as those in the first embodiment and are assigned the same reference signs for explanation.

This battery 401 is a lithium ion secondary battery including the battery case 80 and a power generation element 410 housed in this battery case 80 as in the first embodiment (see FIGS. 1 and 2).

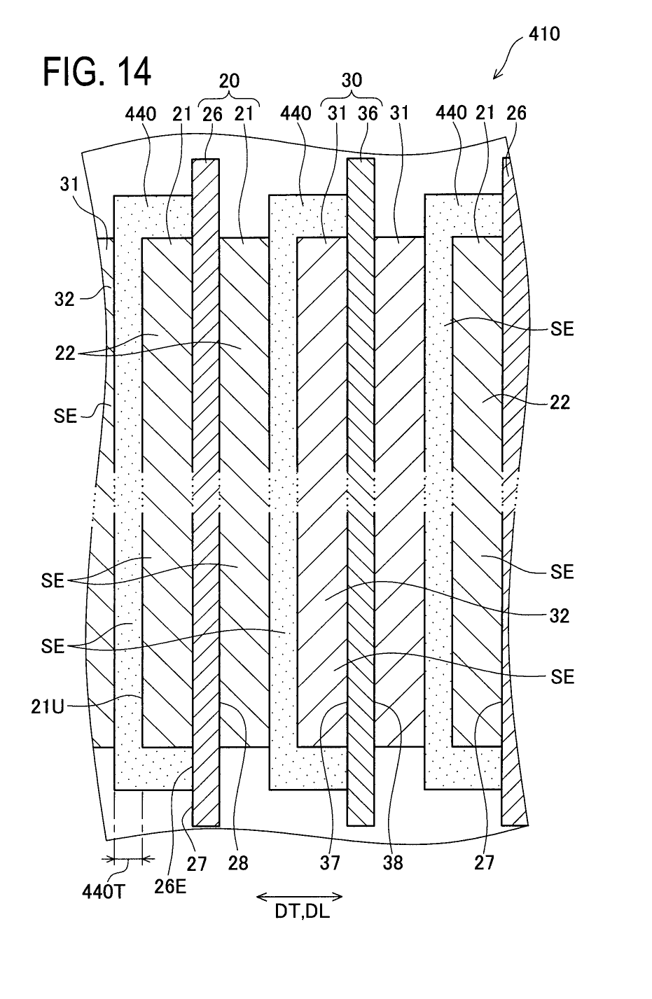

The power generation element 410 is configured as in the first embodiment such that a plurality of positive electrode plates 20 and negative electrode plates 30 are alternately laminated in the lamination direction DL, and a solid electrolyte layer 440 is interposed between the positive active material layer 21 of the positive electrode plate 20 and the negative active material layer 31 of the negative electrode plate 30 adjacent to this positive electrode plate 20 (see FIG. 14).

It is to be noted that the solid electrolyte layer 449 is configured to cover over the adjacent positive active material layer 21.

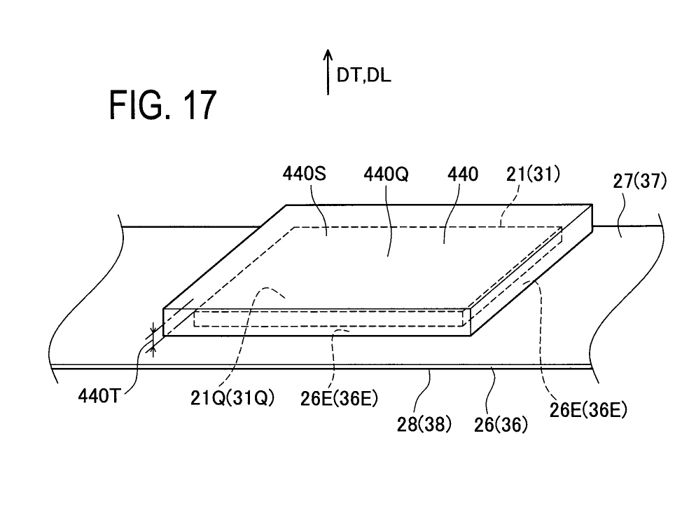

As shown in FIG. 17, specifically, the solid electrolyte layer 440 is formed on a first principal surface 21Q of the positive active material layer 21 and also on a peripheral portion 26E of the positive electrode substrate 26 located around the positive active material layer 21 to cover over the positive active material layer 21 on the positive electrode substrate 26.

In the above processes in the third embodiment, the positive active material layer 21 corresponds to a precedingly-formed active material layer.

This solid electrolyte layer 440 is made of sulfide solid electrolyte SE and formed so that a thickness 440T is 30 μm on the first principal surface 21Q of the positive active material layer 21 (see FIGS. 14 and 17) and an area 440S of a solid layer principal surface 440Q is 194.25 cm² (see FIG. 17).

In the battery 401 in the third embodiment, the solid electrolyte layer 440 is configured to cover over the positive active material layer 21. This can prevent the positive active material layer 21 from directly contacting with the negative active material layer 31 and avoid a short circuit therebetween.

A method of manufacturing the battery 401 in the third embodiment is explained referring to the drawings.

As in the first embodiment, firstly, in the positive active material deposition process and the positive active material compression process, the positive active material layer 21 having the thickness 21T of 30 μm and the area 21S of 180 cm² is formed on one side (the first principal surface 27) of the positive electrode substrate 26 (see FIG. 8).

The electrolyte deposition process for forming the uncompressed solid electrolyte layer 440B is explained referring to FIGS. 5, 7, 15, and 16.

A deposition device 100K used in this electrolyte deposition process, as shown in FIG. 5, includes a supply unit 160Y and a screen 110K having a first screen part 111 and a second screen part 112, in addition to the table 120, the brush 130, and the power source 140 identical to those in the deposition device 100X used in the positive active material deposition process. The supply unit 160Y stores the electrolyte particles SP to supply the electrolyte particles SP onto the screen 110K.

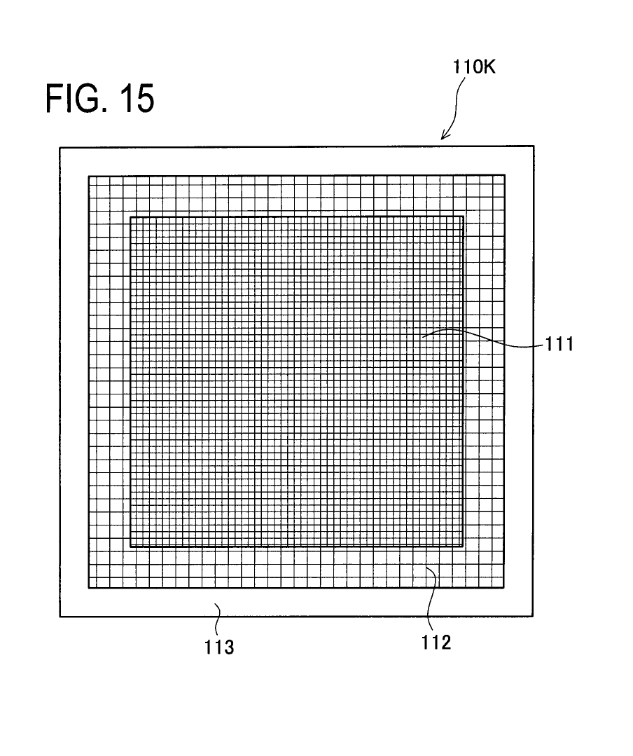

The rectangular mesh screen 110K includes the first screen part 111 of a square shape located in the center thereof, the second screen part 113 of a rectangular annular (a square O) shape surrounding the periphery of the first screen part 111, and a frame part 113 of a rectangular annular shape surrounding the periphery of the second screen part 112 (see FIG. 15). Particles (electrolyte particles SP) pushed through the first screen 111 is accelerated by an electrostatic field, colliding with the first principal surface 21Q of the positive active material layer 21 on the positive electrode substrate 26 and becoming deposited thereon (see FIG. 7). On the other hand, the screen 110K and the positive electrode substrate 26 are arranged so that the electrolyte particles SP pushed through the second screen part 112 collide with the peripheral portion 26E located around the positive active material layer 21 of the positive electrode substrate 26 and be deposited thereon.

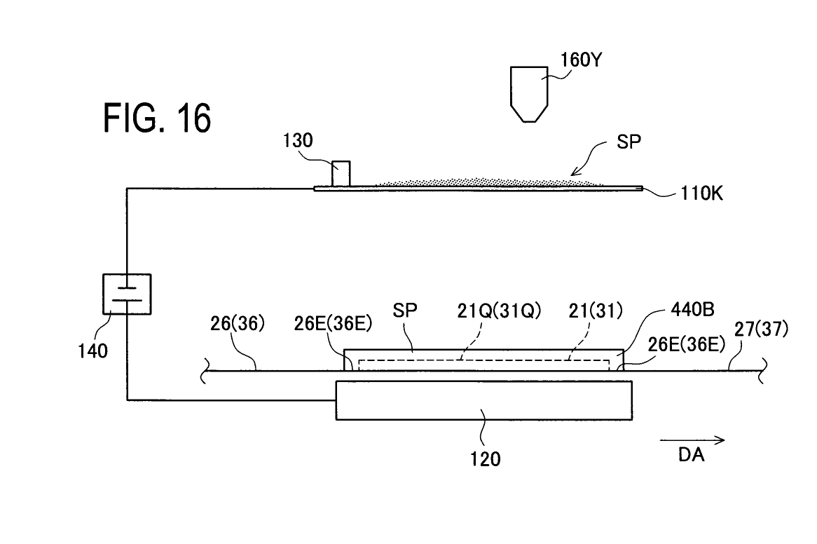

In the electrolyte deposition process in the third embodiment, by the deposition device 100K using the aforementioned screen 110K, the electrolyte particles SP are deposited on the positive active material layer 21 and on the peripheral portion 26E of the positive electrode substrate 26 to form the uncompressed solid electrolyte layer 440B having an area of 194.25 cm² (see FIG. 16). This uncompressed solid electrolyte layer 440B is formed to cover over the positive active material layer 21. Accordingly, the battery 401 can be produced in which direct contact between the positive active material layer 21 and the negative active material layer 31 is appropriately prevented, thereby avoiding a short circuit therebetween.

In the electrolyte deposition process, the electrolyte particles SP are deposited on the peripheral portion 26E so as to be thicker than on the positive active material layer 21. Accordingly, even in what portion of the formed uncompressed solid electrolyte layer 440B, the battery 401 appropriately compressed in the thickness direction DT can be produced.

In addition, the second screen part 112 is designed to have larger meshes than those of the first screen part 111 (see FIG. 15). When the electrolyte deposition process is performed using this screen 110K, the uncompressed solid electrolyte layer 440B can be reliably thick and efficiently deposited on the peripheral portion 26E of the positive electrode substrate 26 as compared that on the positive active material layer 21 (see FIG. 16).

Even in the electrolyte compression process, a compression device 200 K including two metallic press dies 210 is used (see FIG. 5).

The positive electrode substrate 26 is moved in the longitudinal direction DA, and the uncompressed solid electrolyte layer 440B is compressed in the thickness direction DT by use of the two press dies 210 movable in the thickness direction DT, thereby forming the solid electrolyte layer 440 self-maintaining its shape by the bonding force of the electrolyte particles SP. Specifically, the solid electrolyte layer 440 is formed with the thickness 440T of 30 μm and the area 440S of 194.25 cm² (see FIG. 17).

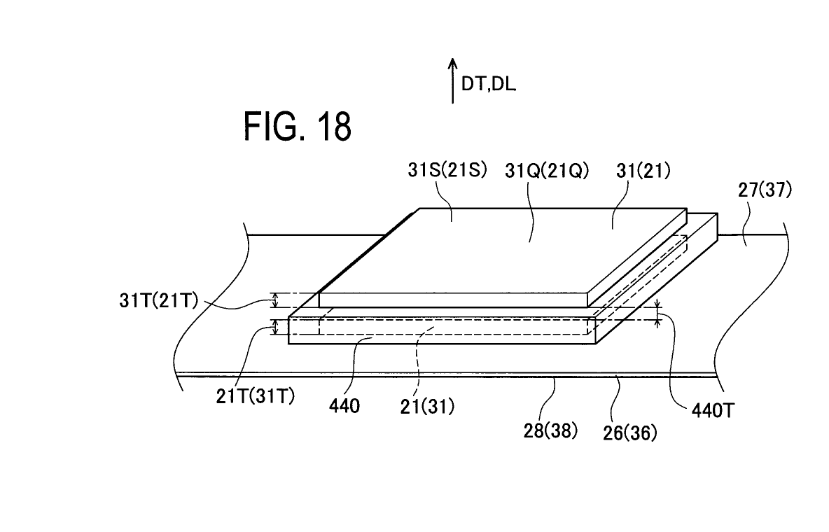

As in the first embodiment, subsequently, in the negative active material deposition process and the negative active material compression process, the negative active material layer 31 is formed with the thickness 31T of 35 μm and the area 31S of 180 cm² (see FIG. 18). Then, the strip-shaped positive electrode substrate 26 is cut in a rectangular shape and at the boundary between portions on each of which the positive active material layer 21, the solid electrolyte layer 440, and negative active material layer 31 are laminated.

Separately from the above, even on the negative electrode substrate 36, as with the same manner for forming the positive active material layer and others on the positive electrode substrate 26, the aforementioned negative active material deposition process, negative active material compression process, electrolyte deposition process, electrolyte compression process, positive active material deposition process, and positive active material compression process are performed in this order (see FIGS. 5, 6, 15, and 16). Thus, the negative active material layer 31, the solid electrolyte layer 440 covering over this negative active material layer 31, and the positive active material layer 21 are laminated on the first principal surface 37 of the negative electrode substrate 36 (see FIG. 18). Successively, the strip-shaped negative electrode substrate 36 is cut in a rectangular shape and at the boundary between portions on each of which the negative active material layer 31, the solid electrolyte layer 440, and the positive active material layer 21 are laminated.

The positive electrode substrates 26 on which the above positive active material layer 21 and others are laminated and the negative electrode substrates 36 on which the negative active material layer 31 and others are laminated are alternately laminated to form a power generation element 410. Specifically, the second principal surface 38 of the negative electrode substrate 36 is bonded to the negative active material layer 31 laminated on the positive electrode substrate 26 and also the second principal surface 28 of the positive electrode substrate 26 is bonded to the positive active material layer 21 laminated on the negative electrode substrate 36 (see FIGS. 3 and 14).

Thereafter, as in the first embodiment, the positive current collector 71 is joined to the positive electrode plate 20 of the power generation element 410 and the negative current collector 72 is joined to the negative electrode plate 30 respectively (see FIG. 3). This power generation element 410 is then inserted in the battery case body 81 and the closing lid 82 is welded to the case body 81 to seal the opening, thus completing the battery 401 (see FIGS. 1 and 2).

### Fourth Embodiment

A battery 501 in a fourth embodiment will be explained below referring to FIGS. 1, 5 to 10, and 19 to 21.

The fourth embodiment is similar to the first embodiment excepting in that a battery 501 is a bipolar battery.

The following explanation is therefore focused on the differences from the first embodiment and the explanation of the similar parts or components is omitted or simplified. Similar parts or components will provide the same operations and effects to those in the first embodiment. Furthermore, similar parts or components are assigned the same reference signs as those in the first embodiment for explanation.

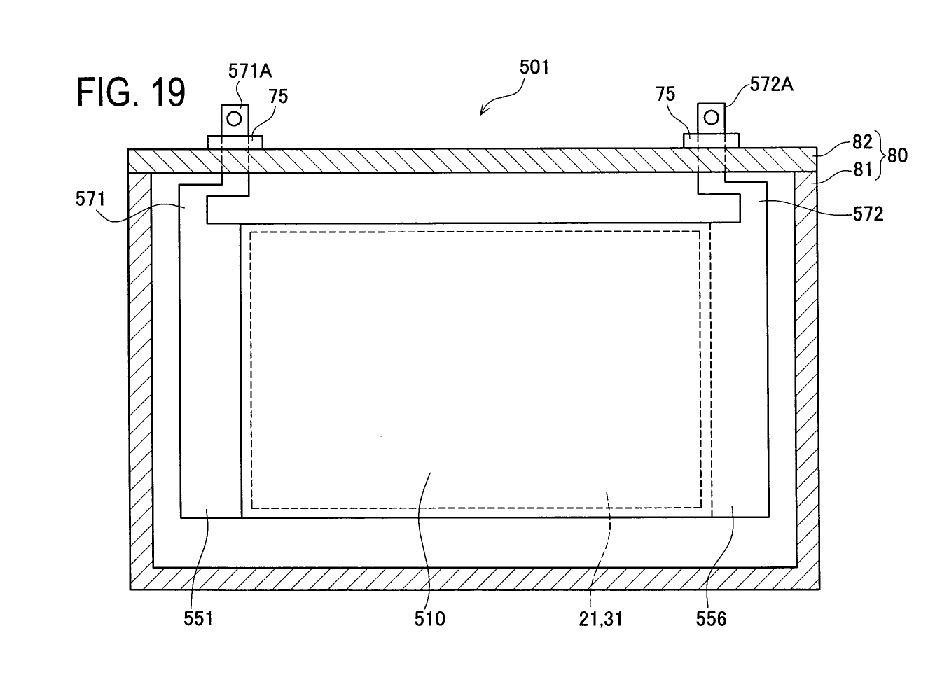

This battery 501 is a bipolar lithium ion secondary battery including the battery case 80 and a power generation element 510 housed in this battery case 80 (see FIGS. 1 and 19).

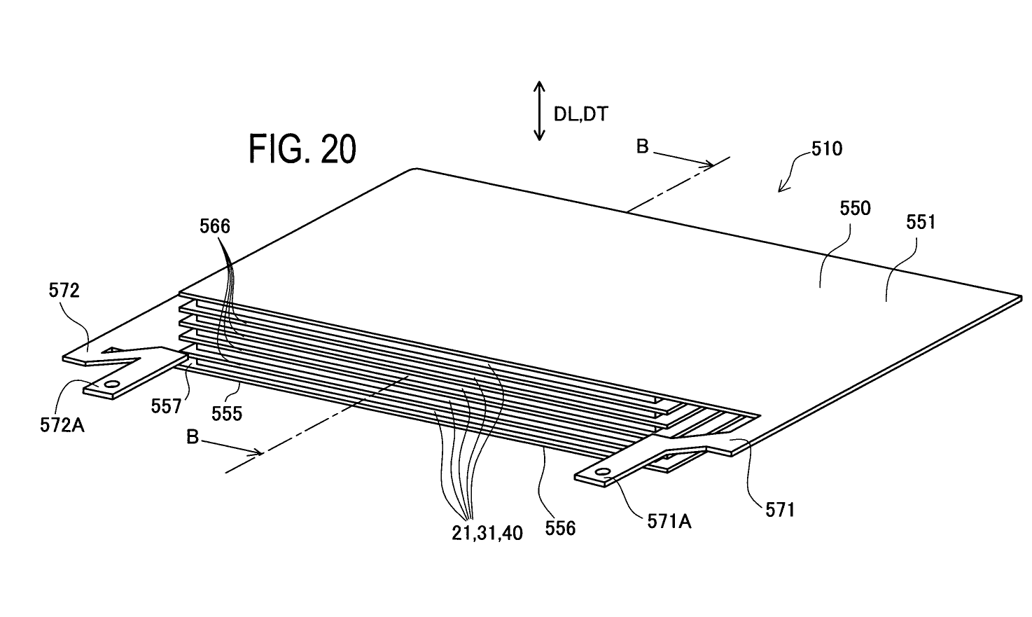

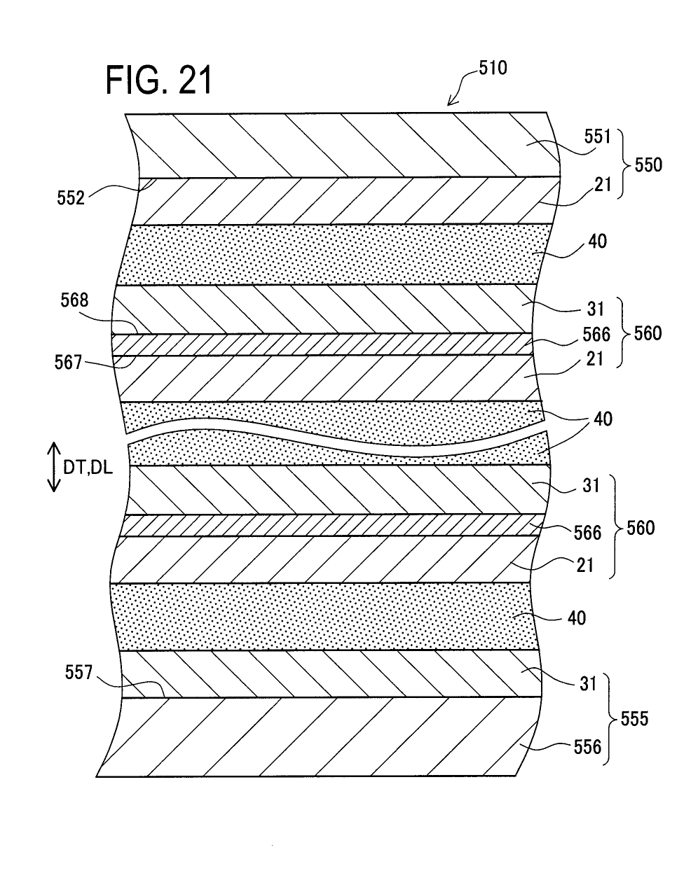

The power generation element 510 includes a total positive electrode substrate 551 located in an uppermost position and a total negative electrode substrate 556 located in a lowermost position in FIG. 20. Between them, the positive active material layers 21, the solid electrolyte layers 40, the negative active material layers 31, and electrode plates 566 made of metal foil are laminated in this order in the lamination direction DL (see FIGS. 20 and 21). Each electrode plate 566 is a rectangular foil shorter than the total positive electrode substrate 551 as to a size from leftmost to front right in FIG. 20.

A concrete explanation is given in turn from the total positive electrode substrate 551 side. The positive active material layer 21 is formed on the principal surface 552 which is one of principal surfaces of the total positive electrode substrate 551 made of aluminum in a rectangular plate shape (see FIG. 21). Furthermore, the solid electrolyte layer 40 is formed under the positive active material layer 21 in FIG. 21 and the negative active material layer 31 is formed under this solid electrolyte layer 40 in the figure, respectively. The electrode plate 566 is placed under the negative active material layer 31 in the figure so that an own second principal surface 568 contacts with the negative active material layer 31. On the first principal surface 567 of this electrode plate 566, the positive active material layer 21 is formed. Under this positive active material layer 21 in FIG. 21, as already explained, the solid electrolyte layers 40, the negative active material layers 31, and the electrode plates 566 are repeatedly laminated. The total negative electrode substrate 556 made of copper in a rectangular plate shape is placed in contact with the lowermost negative active material layer 31 in FIG. 21.

In this power generation element 510, the positive active material layer 21 and the negative active material layer 31 between which the solid electrolyte layer 40 is interposed constitute one unit cell (see FIG. 21). The power generation element 510 is thus configured such that a plurality of unit cells are laminated in series in the lamination direction DL. Accordingly, a total voltage of the voltage between the first electrode plate 550, the second electrode plate 555, and the third electrode plate 560 occurs between the total positive electrode substrate 551 of the first electrode plate 550 and the total negative electrode substrate 556 of the second electrode plate 555.

The total positive electrode substrate 551 includes a positive tab portion 571 and the total negative electrode substrate 556 includes a negative tab portion 572, both tabs extending to left front in FIG. 20. A leading end 571A of this positive tab portion 571 and a leading end 572A of the negative tab portion 572 pass through the closing lid 82 of the battery case 80 and protrude out of the battery case 80 to form external terminals of the battery 501 (see FIGS. 1 and 19).

For manufacturing the battery 501 in the fourth embodiment, the deposition devices 100X, 100Y, and 100Z and the compression devices 200X, 200Y, and 200Z mentioned in the first embodiment are used to form the positive active material layer 21, negative active material layer 31, or the solid electrolyte layer 40 on the electrode plate 566 (or the total positive electrode substrate 551 or the total negative electrode substrate 556).

Specifically, the positive active material deposition process is first performed to form the uncompressed positive active material layer 21B on the total positive electrode substrate 551 (see FIGS. 6B and 7). Then, the positive active material compression process is performed by use of the compression device 200X to form the positive active material layer 21 having the thickness 21T of 30 μm and the area 21S of 180 cm² on the total positive electrode substrate 551 (see FIG. 8).

Subsequently, the electrolyte deposition process and the electrolyte compression process are performed by use of the deposition device 100Y and the compression device 200Y to form the solid electrolyte layer 40 having the thickness 40T of 30 μm and the area 40S of 180 cm² on the positive active material layer 21 (the positive layer principal surface 21Q) formed on the total positive electrode substrate 551 as shown in FIG. 8 (see FIG. 9).

The negative active material deposition process and the negative active material compression process are performed by use of the deposition device 100Z and the compression device 200Z to form the negative active material layer 31 having the thickness 31T of 35 μm and the area 31S of 180 cm² on the solid electrolyte layer 40 (the solid layer principal surface 40Q) as shown in FIG. 9 (see FIG. 10).

After the aforementioned negative active material compression process, the electrode plate 566 of a rectangular flat plate shape is placed on the negative active material layer 31 and pressed in the thickness direction DT to bond the negative active material layer 31 to the electrode plate 566.

Furthermore, the positive active material deposition process, the positive active material compression process, the electrolyte deposition process, the electrolyte compression process, the negative active material deposition process, and the negative active material compression process are performed by repeatedly using the aforementioned deposition devices 100X, 100Y, and 100Z and compression devices 200X, 200Y, and 200Z to form a plurality of the positive active material layers 21, solid electrolyte layers 40, and negative active material layers 31 while interposing each electrode plate 566 between each positive active material layer 21 and each negative active material layer 31. The total negative electrode substrate 556 is last bonded to the negative active material layer 31 formed on the solid electrolyte layer 40. Thus, the aforementioned power generation element 510 is completed (see FIGS. 19 and 20).

In this power generation element 510, the positive tab portion 571 of the total positive electrode substrate 551 and the negative tab portion 572 of the total negative electrode substrate 556 are placed respectively to pass through the closing lid 82. This power generation element 510 is then inserted in the battery case body 81 and the closing lid 82 is welded to the case body 81 to seal the opening. Thus, the battery 501 is finished (see FIG. 1).

### First Modified Example

A battery 601 in a first modified example of the present invention will be explained below referring to the drawings.

In the aforementioned third embodiment 3, the uncompressed solid electrolyte layer 440B is formed to cover over the compressed positive active material layer 21. This first modified embodiment is similar to the third embodiment excepting in that the uncompressed solid electrolyte layer 440B is formed on and to cover over the uncompressed positive active material layer 21B and then those two layers, the uncompressed positive active material layer 21B and the uncompressed solid electrolyte layer 440B, are simultaneously compressed in a two-layer simultaneous compression process.

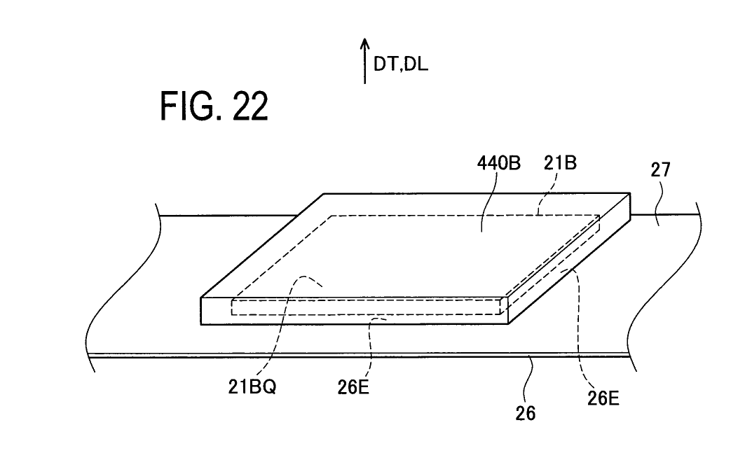

Specifically, the positive active material deposition process using the positive active material deposition device 100X is performed to form the uncompressed positive active material layer 21A on the first principal surface 27 of the positive electrode substrate 26 (see FIG. 7). The electrolyte deposition process using the electrolyte deposition device 100K is then performed to form the uncompressed solid electrolyte layer 440B on the uncompressed positive active material layer 21B before compressing the uncompressed positive active material layer 21B (see FIG. 22).

To be concrete, the uncompressed solid electrolyte layer 440B is formed on the first principal surface 21BQ of the uncompressed positive active material layer 21B and on the peripheral portion 26E of the positive electrode substrate 26 located around the uncompressed positive active material layer 21B. Accordingly, this uncompressed solid electrolyte layer 440B covers over the uncompressed positive active material layer 21B on the positive electrode substrate 26.

Then, the uncompressed positive active material layer 21B and the uncompressed solid electrolyte layer 440B are simultaneously compressed by use of the compression device (two-layer simultaneous compression process) to form the positive active material layer 21 and the solid electrolyte layer 440 configured to cover over the positive active material layer 21.

In the above processed in this first modified example, the uncompressed positive active material layer 21B corresponds to the precedingly-formed uncompressed active material layer.

In the manufacturing method of the battery 601 in this modified example, the uncompressed solid electrolyte layer 440B is formed to cover over the uncompressed positive active material layer 21B. Therefore, the battery 601 can be configured so that the positive active material layer 21 formed by compression of the uncompressed positive active material layer 21B and the negative active material layer 31 formed by compression of the uncompressed negative active material layer 31B directly contact with each other, thereby appropriately preventing a short circuit therebetween.

Thereafter, as in the third embodiment, the negative active material layer 31 is formed on the solid electrolyte layer 440 and then the positive electrode substrate 26 is cut. Separately from this, also on the negative electrode substrate 36, the negative active material layer 31, the solid electrolyte layer 440 configured to cover over this negative active material layer 31, and the positive active material layer 21 are laminated in the same manner as to form the positive active material layer and others on the positive electrode substrate 26. The negative electrode substrate 36 is then cut.

Subsequent steps to complete the power generation element 410 and the battery 601 are the same as those in the third embodiment and are not explained here repeatedly.

### Fifth Embodiment

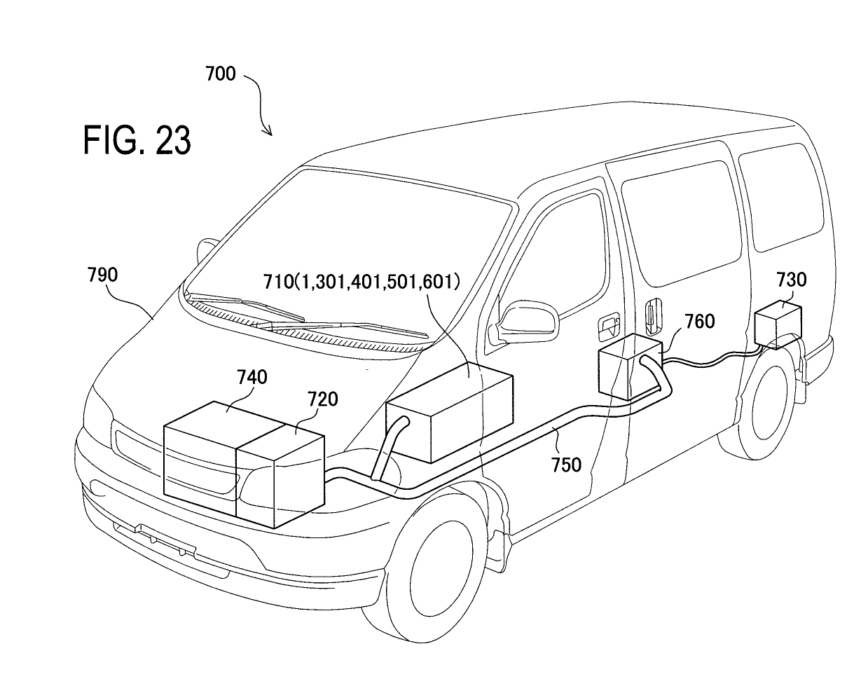

A vehicle 700 in a fifth embodiment mounts therein a plurality of the aforementioned batteries 1, 301, 401, 501, or 601. Specifically, as shown in FIG. 23, the vehicle 700 is a hybrid electric vehicle to be driven by an engine 740, a front motor 720, and a rear motor 730. This vehicle 700 includes a vehicle body 790, the engine 740, the front motor 720 attached thereto, the rear motor 730, a cable 750, an inverter 760, and an assembled battery 710 containing therein the plurality of the batteries 1, 301, 401, 501, or 601.

The vehicle 700 in the fifth embodiment mounts the aforementioned batteries 1, 301, 401, 501 or 601 and therefore can provide high power and achieve a good running performance.

### Sixth Embodiment

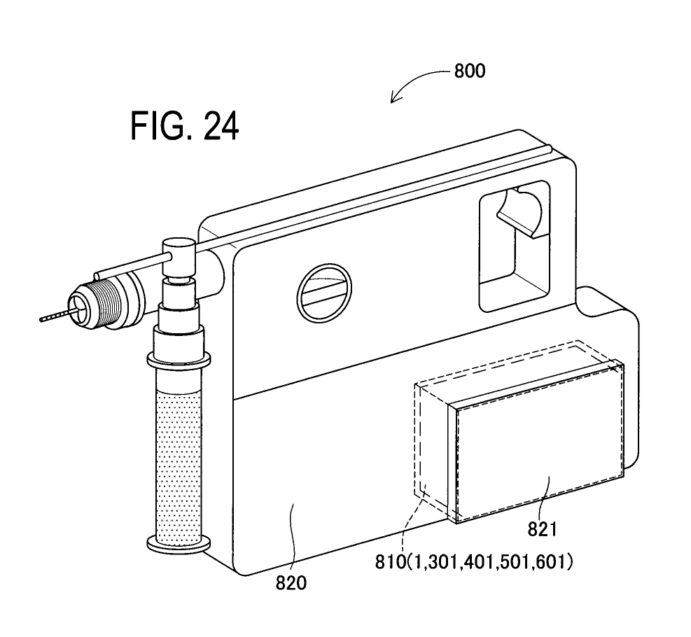

A hammer drill 800 in a sixth embodiment mounts a battery pack 810 containing the aforementioned batteries 1, 301, 401, 501, or 601. The hammer drill 800 is also a battery-mounting device having the battery pack 810 and a main body 820 as shown in FIG. 24. the battery pack 810 is removably housed in the main body 820 at a bottom 821 of the hammer drill 800.

The hammer drill 800 in this sixth embodiment mounts the aforementioned batteries 1, 301, 401, 501, or 601 and thus can be achieved as a battery-mounting device providing high power and achieving good characteristics.

The present invention is explained as above along the first to sixth embodiments and the first modified example. However, the present invention is not limited to the above embodiments and modified example and may be appropriately embodied in other specific forms without departing from the essential characteristics thereof.

For instance, besides the manufacturing method of the solid electrolyte battery disclosed in the first embodiment, second embodiment, third embodiment, and first modified example, the two-layer simultaneous compression process may be performed to simultaneously compress two layers (uncompressed positive active material layer and uncompressed solid electrolyte layer) after the positive active material deposition process and the electrolyte deposition process are conducted. Alternatively, for example, after formation of the positive active material layer, the two-layer simultaneous compression process may be performed to two layers (uncompressed solid electrolyte layer and uncompressed negative active material layer) formed in the electrolyte compression process and the negative active material deposition process.

In the first to third embodiments and first modified example, the solid electrolyte battery of an alternate lamination type is produced by alternately laminating the positive electrode substrates 26 and the negative electrode substrates 36. As shown in the fourth embodiment, a solid electrolyte battery of a bipolar type may be produced instead by the manufacturing methods shown in the first to third embodiments and others.

In the aforementioned deposition device, a mask having a rectangular through hole for forming an uncompressed active material layer of a flat rectangular shape in a desired place on an electrode plate may be arranged between the screen and the electrode plate.

Furthermore, a conduction auxiliary agent may be contained in the positive active material layer or the negative active material layer.

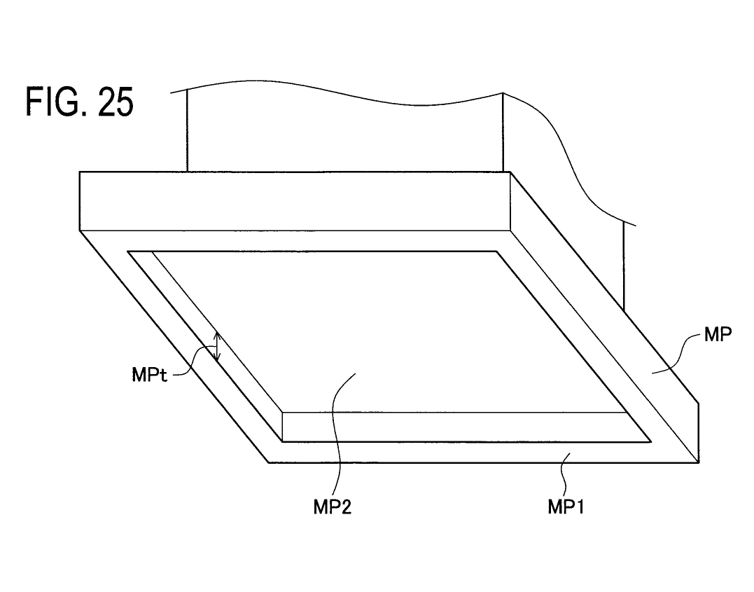

In the third embodiment using the deposition device 100K, the electrolyte particles are deposited thicker on the peripheral portion of the substrate around the active material layer than on the positive active material layer, forming the uncompressed solid electrolyte layer, which is then compressed to form the solid electrolyte layer. However, for example, the solid electrolyte layer may be formed by depositing the same amount of electrolyte particles on the peripheral portion of the electrode plate around the active material layer and on the positive active material layer to form the uncompressed solid electrolyte layer, and then compressing the uncompressed solid electrolyte layer together with the positive active material layer 21 by use of a die MP provided with a recess MP2 on the uncompressed solid electrolyte layer side as shown in FIG. 25.

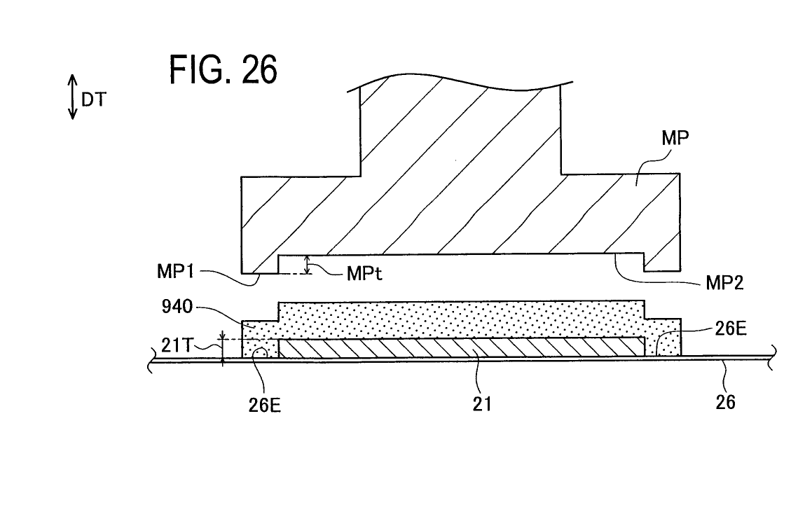

This die MP includes a rectangular annular surface MP1 and the rectangular recess MP2 surrounded by this annular surface MP1. A size MPt (depth) of the recess MP2 in the layer thickness direction DT (a vertical direction in FIG. 26) is equal to the layer thickness 21T of the positive active material layer 21. Accordingly, by the annular surface MP1 and the recess MP2 of this die MP, the uncompressed solid electrolyte layer can be evenly compressed on both of the peripheral portion 26E and the positive active material layer 21. The formed solid electrolyte layer 940 can provide sufficient strength to maintain its shape in the peripheral portion 26E and the positive active material layer 21.

1. A solid electrolyte battery comprising:
a positive active material layer containing positive active material particles;
a negative active material layer containing negative active material particles; and
a solid electrolyte layer interposed between the positive active material layer and the negative active material layer,
wherein the solid electrolyte layer contains a sulfide solid electrolyte but no resin binder,
the solid electrolyte layer self-maintains its shape by a bonding force of the sulfide solid electrolyte,
the solid electrolyte layer has a layer thickness of 50 μm or less and an area of 100 cm² or more.

2. The solid electrolyte battery according to claim 1, wherein
the positive active material layer contains the sulfide solid electrolyte but no resin binder,
the positive active material particles are bonded together by the sulfide solid electrolyte and the positive active material layer self-maintains its shape by bonding force of the sulfide solid electrolyte,
the positive active material layer has a layer thickness of 100 μm or less and an area of 100 cm² or more, and
the negative active material layer contains the sulfide solid electrolyte but no resin binder,
the negative active material particles are bonded together through the sulfide solid electrolyte and the negative active material layer self-maintains its shape by the bonding force of the sulfide solid electrolyte,
the negative active material layer has a layer thickness of 100 μm or less and an area of 100 cm² or more.

3. A solid electrolyte battery comprising:
a positive active material layer containing positive active material particles;
a negative active material layer containing negative active material particles; and
a solid electrolyte layer interposed between the positive active material layer and the negative active material layer,
wherein the solid electrolyte layer contains a sulfide solid electrolyte but no resin binder,
the solid electrolyte layer is formed by depositing electrolyte particles made of the sulfide solid electrolyte by use of an electrostatic screen printing method and compressing the deposited particles in a layer thickness direction, and
the solid electrolyte layer self-maintains its shape by a bonding force of the sulfide solid electrolyte.

4. The solid electrolyte battery according to claim 3, wherein
the positive active material layer contains the sulfide solid electrolyte but no resin binder,
the positive active material layer is formed by depositing first mixed particles of the positive active material particles and the electrolyte particles by use of an electrostatic screen printing method, and compressing the deposited particles in the layer thickness direction,
the positive active material particles are bonded together through the sulfide solid electrolyte and the positive active material layer self-maintains its shape by the bonding force of the sulfide solid electrolyte,
the negative active material layer contains the sulfide solid electrolyte but no resin binder,
the negative active material layer is formed by depositing second mixed particles of the negative active material particles and the electrolyte particles by use of an electrostatic screen printing method, and compressing the deposited particles in the layer thickness direction, and
the negative active material particles are bonded together through the sulfide solid electrolyte and the negative active material layer self-maintains its shape by the bonding force of the sulfide solid electrolyte.

5. The solid electrolyte battery according to claim 1, wherein
the solid electrolyte layer is formed on a precedingly-formed active material layer formed on a conductive electrode plate, the precedingly-formed active material layer being is one of the positive active material layer and the negative active material layer, and also the solid electrolyte layer is formed on a peripheral portion of the electrode plate around the precedingly-formed active material layer so that the solid electrolyte layer covers over the precedingly-formed active material layer.

6. A vehicle mounting the solid electrolyte battery according to claim 1.

7. A battery-mounting device mounting the solid electrolyte battery according to claim 1.

8. A manufacturing method of a solid electrolyte battery,
the solid electrolyte battery comprising:
a positive active material layer containing positive active material particles;
a negative active material layer containing negative active material particles; and
a solid electrolyte layer interposed between the positive active material layer and the negative active material layer,
wherein the solid electrolyte layer contains a sulfide solid electrolyte but no resin binder,
the method comprises:
an electrolyte deposition process for depositing electrolyte particles made of the sulfide solid electrolyte by an electrostatic screen printing method to form an uncompressed solid electrolyte layer; and
an electrolyte compression process for compressing the uncompressed solid electrolyte layer in a layer thickness direction to form the solid electrolyte layer that self-maintains its shape by a bonding force of the sulfide solid electrolyte.

9. The manufacturing method of the solid electrolyte battery according to claim 8, wherein
the positive active material layer contains a sulfide solid electrolyte but no resin binder,
the negative active material layer contains a sulfide solid electrolyte but no resin binder,
the method comprises:
a positive active material deposition process for depositing first mixed particles of the positive active material particles and the electrolyte particles to form an uncompressed positive active material layer by an electrostatic screen printing method;
a positive active material compression process for compressing the uncompressed positive active material layer in the layer thickness direction to bond the positive active material particles together through the sulfide solid electrolyte to thereby form the positive active material layer that self-maintains its shape by the bonding force of the sulfide solid electrolyte;
a negative active material deposition process for depositing second mixed particles of the negative active material particles and the electrolyte particles to form an uncompressed negative active material layer by the electrostatic screen printing method; and
a negative active material compression process for compressing the uncompressed negative active material layer in the layer thickness direction to bond the negative active material particles together through the sulfide solid electrolyte to thereby form the negative active material layer that self-maintains its shape by the bonding force of the sulfide solid electrolyte.

10. The manufacturing method of the solid electrolyte battery according to claim 8, wherein
the electrolyte deposition process includes forming the uncompressed solid electrolyte layer by depositing the electrolyte particles on a precedingly-formed active material layer formed on a conductive electrode plate, the precedingly-formed active material layer being one of the positive active material layer and the negative active material layer and also on a peripheral portion the electrode plate located around the precedingly-formed active material layer to cover over the precedingly-formed active material layer.

11. The manufacturing method of the solid electrolyte battery according to claim 9, wherein
the electrolyte deposition process includes forming the uncompressed solid electrolyte layer by depositing the electrolyte particles on a precedingly-formed uncompressed active material layer formed on a conductive electrode plate, the precedingly-formed uncompressed active material layer being one of the uncompressed positive active material layer and the uncompressed negative active material layer, and also on a peripheral portion of the electrode plate located around the precedingly-formed active material layer to cover over the precedingly-formed active material layer.

12. The manufacturing method of the solid electrolyte battery according to claim 10, wherein
the electrolyte deposition process includes depositing the electrolyte particles thicker on the peripheral portion of the electrode plate than on the precedingly-formed active material layer or the precedingly-formed uncompressed active material layer.

13. The manufacturing method of the solid electrolyte battery according to claim 12, wherein
the electrolyte deposition process is performed by use of a mesh screen including a first screen part located corresponding to the precedingly-formed active material layer or the precedingly-formed uncompressed active material layer and a second screen part located corresponding to the peripheral portion around the active material layer, the second screen part having a larger mesh opening size than that of the first screen part.

14. The manufacturing method of the solid electrolyte battery according to claim 9, wherein
one of the positive active material deposition process and the negative active material deposition process is performed as a preceding active material deposition process prior to the electrolyte deposition process,
the other of the positive active material deposition process and the negative active material deposition process is performed as a succeeding active material deposition process after the electrolyte deposition process,
the electrolyte compression process, the positive active material compression process, and the negative active material compression process are simultaneously performed after the succeeding active material deposition process, and
the uncompressed solid electrolyte layer, the uncompressed positive active material layer, and the uncompressed negative active material layer are simultaneously compressed to form the solid electrolyte layer, the positive active material layer, and negative active material layer.

15. The solid electrolyte battery according to claim 3, wherein
the solid electrolyte layer is formed on a precedingly-formed active material layer formed on a conductive electrode plate, the precedingly-formed active material layer being is one of the positive active material layer and the negative active material layer, and also the solid electrolyte layer is formed on a peripheral portion of the electrode plate around the precedingly-formed active material layer so that the solid electrolyte layer covers over the precedingly-formed active material layer.

16. A vehicle mounting the solid electrolyte battery according to claim 3.

17. A battery-mounting device mounting the solid electrolyte battery according to claim 3.

18. The manufacturing method of the solid electrolyte battery according to claim 9, wherein
the electrolyte deposition process includes forming the uncompressed solid electrolyte layer by depositing the electrolyte particles on a precedingly-formed active material layer formed on a conductive electrode plate, the precedingly-formed active material layer being one of the positive active material layer and the negative active material layer and also on a peripheral portion the electrode plate located around the precedingly-formed active material layer to cover over the precedingly-formed active material layer.

19. The manufacturing method of the solid electrolyte battery according to claim 11, wherein
the electrolyte deposition process includes depositing the electrolyte particles thicker on the peripheral portion of the electrode plate than on the precedingly-formed active material layer or the precedingly-formed uncompressed active material layer.

20. The manufacturing method of the solid electrolyte battery according to claim 19, wherein
the electrolyte deposition process is performed by use of a mesh screen including a first screen part located corresponding to the precedingly-formed active material layer or the precedingly-formed uncompressed active material layer and a second screen part located corresponding to the peripheral portion around the active material layer, the second screen part having a larger mesh opening size than that of the first screen part.
